(19) United States
(12) Patent Application Publication
(10) Pub. No.: US 2025/0016761 A1
(43) Pub. Date: Jan. 9, 2025

(54) SIGNALING FOR BASE STATION-CONTROLLED SIDELINK GRANTS

(71) Applicant: QUALCOMM Incorporated, San Diego, CA (US)

(72) Inventors: Luanxia YANG, Beijing (CN); Piyush GUPTA, Bridgewater, NJ (US); Xiaojie WANG, Hillsborough, NJ (US)

(21) Appl. No.: 18/706,211

(22) PCT Filed: Jan. 5, 2022
(86) PCT No.: PCT/CN2022/070233

§ 371 Date: Apr. 30, 2024

(51) Int. Cl. H04W 72/11; H04W 48/16; H04W 72/23

(52) U.S. Cl. CPC H04W 72/11; H04W 48/16; H04W 72/23

(57) ABSTRACT

Methods, systems, and devices for wireless communications are described. A wireless node (e.g., which may be a programmable logic controller (PLC), a central node, a sidelink user equipment (UE), or the like) may communicate with a base station via a first wireless communication link and with another UE (e.g., a sensor/actuator (S/A), a child node, another sidelink UE, or the like) via a second wireless communications link. The wireless node may receive, from the base station via the first wireless communication link, a grant of resources associated with the second wireless communication link, where the grant of resources is encoded with a shared radio network temporary identifier (RNTI) that is shared by both the wireless node and the UE. The wireless node may determine, based at least in part on the shared RNTI, that the grant of resources is for the UE, and forward the grant to the UE.

### CROSS REFERENCE

The present application is a 371 national phase filing of International PCT Application No. PCT/CN2022/070233 by YANG et al., entitled “SIGNALING FOR BASE STATION-CONTROLLED SIDELINK GRANTS,” filed Jan. 5, 2022, which is assigned to the assignee hereof, and which is expressly incorporated by reference in its entirety herein.

### FIELD OF TECHNOLOGY

The following relates to wireless communications, including signaling for base station-controlled sidelink grants.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

### SUMMARY

The described techniques relate to improved methods, systems, devices, and apparatuses that support signaling for base station-controlled sidelink grants. Generally, a wireless node (e.g., which may be a programmable logic controller (PLC), a central node, a sidelink user equipment (UE), or the like) may communicate with a base station via a first wireless communication link and with another UE (e.g., a sensor/actuator (S/A), a child node, another sidelink UE, or the like) via a second wireless communications link. The wireless node may receive, from the base station via the first wireless communication link, a grant of resources associated with the second wireless communication link, where the grant of resources is encoded with a shared radio network temporary identifier (RNTI) that is shared by both the wireless node and the UE. The wireless node may determine, based at least in part on the shared RNTI, that the grant of resources is for the UE, and forward the grant to the UE.

A method for wireless communications at a wireless node is described. The method may include communicating with a base station via a first wireless communication link and with a UE via a second wireless communication link, receiving, from the base station via the first wireless communication link, a grant of resources associated with the second wireless communication link, where the grant of resources is encoded with a shared RNTI that is shared by both the wireless node and the UE, determining, based on the shared RNTI, that the grant of resources is for the UE, and forwarding the grant to the UE.

An apparatus for wireless communications at a wireless node is described. The apparatus may include a processor, memory coupled with the processor, and instructions stored in the memory. The instructions may be executable by the processor to cause the apparatus to communicate with a base station via a first wireless communication link and with a UE via a second wireless communication link, receive, from the base station via the first wireless communication link, a grant of resources associated with the second wireless communication link, where the grant of resources is encoded with a shared RNTI that is shared by both the wireless node and the UE, determine, based on the shared RNTI, that the grant of resources is for the UE, and forward the grant to the UE.

Another apparatus for wireless communications at a wireless node is described. The apparatus may include means for communicating with a base station via a first wireless communication link and with a UE via a second wireless communication link, means for receiving, from the base station via the first wireless communication link, a grant of resources associated with the second wireless communication link, where the grant of resources is encoded with a shared RNTI that is shared by both the wireless node and the UE, means for determining, based on the shared RNTI, that the grant of resources is for the UE, and means for forwarding the grant to the UE.

A non-transitory computer-readable medium storing code for wireless communications at a wireless node is described. The code may include instructions executable by a processor to communicate with a base station via a first wireless communication link and with a UE via a second wireless communication link, receive, from the base station via the first wireless communication link, a grant of resources associated with the second wireless communication link, where the grant of resources is encoded with a shared RNTI that is shared by both the wireless node and the UE, determine, based on the shared RNTI, that the grant of resources is for the UE, and forward the grant to the UE.

Some examples of the method, apparatuses, and non-transitory computer-readable medium described herein may further include operations, features, means, or instructions for monitoring a search space of a control resource set associated with the wireless node on the first wireless communication link for a downlink control information (DCI) message that includes the grant of resources, where the DCI message may be encoded with the shared RNTI which may be an identifier of the wireless node, and where receiving the grant of resources may be based on the monitoring.

Some examples of the method, apparatuses, and non-transitory computer-readable medium described herein may further include operations, features, means, or instructions for receiving, in a field of the DCI message including the grant of resources, a destination identifier associated with the UE, where the determining may be based on receiving the destination identifier.

Some examples of the method, apparatuses, and non-transitory computer-readable medium described herein may further include operations, features, means, or instructions for decoding a cyclic redundancy check associated with the grant of resources and identifying, based on the decoding, the shared RNTI which may be the identifier of the wireless node and a destination identifier associated with the UE, where the determining may be based on identifying the destination identifier.

Some examples of the method, apparatuses, and non-transitory computer-readable medium described herein may further include operations, features, means, or instructions for receiving, from the base station via the first wireless communication link, a second grant of resources associated with the second wireless communication link, where the second grant of resources may be encoded with a second shared RNTI that may be shared by both the wireless node and the UE, identifying, in the second grant of resources, an identifier associated with the wireless node, determining, based on the second shared RNTI and the identifier associated with the wireless node, that the second grant of resources may be for the wireless node, and performing sidelink communications on the second wireless communication link according to the second grant of resources.

Some examples of the method, apparatuses, and non-transitory computer-readable medium described herein may further include operations, features, means, or instructions for receiving, from the base station via the first wireless communication link, a second grant of resources associated with the second wireless communication link, where the second grant of resources may be encoded with a second shared RNTI that may be shared by both the wireless node and the UE, decoding a cyclic redundancy check associated with the second grant of resources, determining, based on the second shared RNTI and an absence of an identifier associated with the UE, that the second grant of resources may be for the wireless node, and performing sidelink communications on the second wireless communication link according to the second grant of resources.

Some examples of the method, apparatuses, and non-transitory computer-readable medium described herein may further include operations, features, means, or instructions for receiving, from the base station, an indication of a set of RNTIs associated with respective UEs of a set of UEs including the UE, where the set of RNTIs includes the shared RNTI and monitoring, using the shared RNTI based on receiving the indication of the set of RNTIs, a search space of a control resource set associated with wireless node on the first wireless communication link for a DCI message that includes the grant of resources, where the DCI message may be encoded with the shared RNTI which may be an identifier of the UE.

Some examples of the method, apparatuses, and non-transitory computer-readable medium described herein may further include operations, features, means, or instructions for receiving, in a field of the DCI message including the grant of resources, a one-bit indication that the grant of resources may be for the UE, where the determining may be based on receiving the one-bit indication.

Some examples of the method, apparatuses, and non-transitory computer-readable medium described herein may further include operations, features, means, or instructions for decoding a cyclic redundancy check associated with the grant of resources and identifying, based on the decoding, the shared RNTI which may be the identifier of the UE and a destination identifier associated with the UE, where the determining may be based on identifying the destination identifier.

In some examples of the method, apparatuses, and non-transitory computer-readable medium described herein, the set of UEs includes respective UEs that may be operating in a connected mode with the UE.

Some examples of the method, apparatuses, and non-transitory computer-readable medium described herein may further include operations, features, means, or instructions for receiving, from the base station, an indication of a search space associated with the UE and monitoring the search space for the grant of resources, where the determining may be based on the monitoring the search space.

Some examples of the method, apparatuses, and non-transitory computer-readable medium described herein may further include operations, features, means, or instructions for determining an offset between a search space associated with the wireless node and a search space associated with the UE and monitoring the search space associated with the UE for the grant of resources, where the determining may be based on the monitoring the search space associated with the UE.

In some examples of the method, apparatuses, and non-transitory computer-readable medium described herein, the shared RNTI may be a cell-specific RNTI.

In some examples of the method, apparatuses, and non-transitory computer-readable medium described herein, the wireless node includes a programmable logic controller of an industrial internet of things deployment and the UE includes a sensor/actuator of the industrial internet of things deployment, where the UE may be in a star topology with the wireless node.

In some examples of the method, apparatuses, and non-transitory computer-readable medium described herein, the wireless node includes a central sidelink UE of a set of multiple connected sidelink UEs.

In some examples of the method, apparatuses, and non-transitory computer-readable medium described herein, the first wireless communication link includes a cellular communications link and the second wireless communication link includes a sidelink communications link.

A method for wireless communications at a base station is described. The method may include communicating with a wireless node via a first wireless communication link, encoding a grant of resources with a shared RNTI that is shared by both the wireless node and a UE, where the grant of resources is associated with a second wireless communication link for communication between the wireless node and the UE, and transmitting, to the wireless node via the first wireless communication link, the grant of resources.

An apparatus for wireless communications at a base station is described. The apparatus may include a processor, memory coupled with the processor, and instructions stored in the memory. The instructions may be executable by the processor to cause the apparatus to communicate with a wireless node via a first wireless communication link, encode a grant of resources with a shared RNTI that is shared by both the wireless node and a UE, where the grant of resources is associated with a second wireless communication link for communication between the wireless node and the UE, and transmit, to the wireless node via the first wireless communication link, the grant of resources.

Another apparatus for wireless communications at a base station is described. The apparatus may include means for communicating with a wireless node via a first wireless communication link, means for encoding a grant of resources with a shared RNTI that is shared by both the wireless node and a UE, where the grant of resources is associated with a second wireless communication link for communication between the wireless node and the UE, and means for transmitting, to the wireless node via the first wireless communication link, the grant of resources.

A non-transitory computer-readable medium storing code for wireless communications at a base station is described. The code may include instructions executable by a processor to communicate with a wireless node via a first wireless communication link, encode a grant of resources with a shared RNTI that is shared by both the wireless node and a UE, where the grant of resources is associated with a second wireless communication link for communication between the wireless node and the UE, and transmit, to the wireless node via the first wireless communication link, the grant of resources.

In some examples of the method, apparatuses, and non-transitory computer-readable medium described herein, transmitting the grant of resources may include operations, features, means, or instructions for transmitting a DCI message that includes the grant of resources in a search space of a control resource set associated with the wireless node on the first wireless communication link, where the DCI message may be encoded with the shared RNTI which may be an identifier of the wireless node.

Some examples of the method, apparatuses, and non-transitory computer-readable medium described herein may further include operations, features, means, or instructions for including, in a field of the DCI message including the grant of resources, a destination identifier associated with the UE.

Some examples of the method, apparatuses, and non-transitory computer-readable medium described herein may further include operations, features, means, or instructions for encoding a cyclic redundancy check associated with the grant of resources using the RNTI which may be the identifier of the wireless node and a destination identifier associated with the UE, where the transmitting may be based on encoding the cyclic redundancy check.

Some examples of the method, apparatuses, and non-transitory computer-readable medium described herein may further include operations, features, means, or instructions for determining that a second grant of resources associated with the second wireless communication link may be for the wireless node and transmitting, to the wireless node via the first wireless communication link based on the determining, the second grant of resources, where the second grant of resources may be encoded with a second shared RNTI that may be shared by both the wireless node and the UE, and where the second grant of resources includes an indication of an identifier associated with the wireless node.

Some examples of the method, apparatuses, and non-transitory computer-readable medium described herein may further include operations, features, means, or instructions for determining that a second grant of resources associated with the second wireless communication link may be for the wireless node, refraining from encoding a cyclic redundancy check associated with the second grant of resources using an identifier associated with the UE, and transmitting, to the wireless node via the first wireless communication link based on the determining, the second grant of resources, where the second grant of resources may be encoded with a second shared RNTI that may be shared by both the wireless node and the UE.

Some examples of the method, apparatuses, and non-transitory computer-readable medium described herein may further include operations, features, means, or instructions for transmitting, to the wireless node, an indication of a set of RNTIs associated with respective UEs of a set of UEs including the UE, where the set of RNTIs includes the shared RNTI and determining that the grant of resources may be for the UE, where transmitting the grant of resources includes transmitting a DCI message that includes the grant of resources on a search space of a control resource set associated with the wireless node on the first wireless communication link, where the DCI message may be encoded with the shared RNTI which may be an identifier of the UE.

Some examples of the method, apparatuses, and non-transitory computer-readable medium described herein may further include operations, features, means, or instructions for including, in a field of the DCI message including the grant of resources, a one-bit indication that the grant of resources may be for the UE.

In some examples of the method, apparatuses, and non-transitory computer-readable medium described herein, encoding the grant of resources may include operations, features, means, or instructions for encoding a cyclic redundancy check associated with the grant of resources using the shared RNTI which may be the identifier of the UE and a destination identifier associated with the UE.

Some examples of the method, apparatuses, and non-transitory computer-readable medium described herein may further include operations, features, means, or instructions for transmitting, to the wireless node, the UE, or both, an indication of a search space associated with the UE, where transmitting the grant of resources includes transmitting the grant of resources on the search space associated with the UE.

Some examples of the method, apparatuses, and non-transitory computer-readable medium described herein may further include operations, features, means, or instructions for determining an offset between a search space associated with the wireless node and a search space associated with the UE, where transmitting the grant of resources includes transmitting the grant of resources via the search space associated with the UE.

In some examples of the method, apparatuses, and non-transitory computer-readable medium described herein, the wireless node includes a programmable logic controller of an industrial internet of things deployment and the UE includes a sensor/actuator of the industrial internet of things deployment, where the UE may be in a star topology with the wireless node.

### BRIEF DESCRIPTION OF THE DRAWINGS

FIG. 1 illustrates an example of a wireless communications system that supports signaling for base station-controlled sidelink grants in accordance with aspects of the present disclosure.

FIG. 2 illustrates an example of a wireless communications system that supports signaling for base station-controlled sidelink grants in accordance with aspects of the present disclosure.

FIG. 3 illustrates an example of a resource configuration that supports signaling for base station-controlled sidelink grants in accordance with aspects of the present disclosure.

FIG. 4 illustrates an example of a wireless communications system that supports signaling for base station-controlled sidelink grants in accordance with aspects of the present disclosure.

FIG. 5 illustrates an example of a timeline that supports signaling for base station-controlled sidelink grants in accordance with aspects of the present disclosure.

FIG. 6 illustrates an example of a timeline that supports signaling for base station-controlled sidelink grants in accordance with aspects of the present disclosure.

FIG. 7 illustrates an example of a process flow that supports signaling for base station-controlled sidelink grants in accordance with aspects of the present disclosure.

FIGS. 8 and 9 show block diagrams of devices that support signaling for base station-controlled sidelink grants in accordance with aspects of the present disclosure.

FIG. 10 shows a block diagram of a communications manager that supports signaling for base station-controlled sidelink grants in accordance with aspects of the present disclosure.

FIG. 11 shows a diagram of a system including a device that supports signaling for base station-controlled sidelink grants in accordance with aspects of the present disclosure.

FIGS. 12 and 13 show block diagrams of devices that support signaling for base station-controlled sidelink grants in accordance with aspects of the present disclosure.

FIG. 14 shows a block diagram of a communications manager that supports signaling for base station-controlled sidelink grants in accordance with aspects of the present disclosure.

FIG. 15 shows a diagram of a system including a device that supports signaling for base station-controlled sidelink grants in accordance with aspects of the present disclosure.

FIGS. 16 through 19 show flowcharts illustrating methods that support signaling for base station-controlled sidelink grants in accordance with aspects of the present disclosure.

### DETAILED DESCRIPTION

A wireless communication system may support sidelink communications. In such examples, user equipments (UEs) may communicate with each other via sidelink resources. For example, in an industrial internet of things (IIoT) deployment, a base station may communicate with one or more programmable logic controllers (PLCs) via a Uu interface, and the PLC may communicate with multiple sensors/actuators (S/As) via a PC5 interface (via sidelink). The configuration of the S/As and the PLC may be in the form of a star, with the PLC in the middle (a star topology). The S/As may also be in communication with the base station. In a more general topology, a base station may communicate with a UE that is not a central node or PLC via the Uu interface, and the UE may communicate with one or more other UEs via the PC5 interface. In any such examples, the base station may schedule sidelink communications for other UEs (e.g., child UEs, S/As, etc.) via a wireless node (e.g., the PLC, central node, or scheduling UE, etc.). To do so, the base station transmits a grant of sidelink resources to the wireless node. However, upon receiving the grant, the wireless node may need to determine whether the grant of sidelink resources is for the wireless node itself, or for one of the other UEs. Some wireless communications systems may lack a mechanism by which to indicate which device a grant is for.

As described herein, a base station may encode a grant of sidelink resources for a wireless device (e.g., for a wireless node or for another UE that is connected to the wireless node) using a shared random network temporary identifier (RNTI). The shared RNTI may be the RNTI of the wireless node, or of the receiving UE that is in sidelink communications with the wireless node. For example, the base station may transmit a downlink control information (DCI) message that includes the grant of resources on a search space for the wireless node (e.g., the PLC, central node, UE, etc.), and may encode the grant using the RNTI of the wireless node. The RNTI may be shared by the wireless node and other UEs in sidelink communication with the wireless node. In this way, the wireless node may determine that the grant is for either it or one of the connected devices. The base station may indicate that the grant is for one of the wireless node or a sidelink-connected UE in a field in the DCI. In some examples, the base station may indicate that the grant is for the wireless node or the sidelink-connected UE using a new mask for the cyclic redundancy check (CRC) value for the DCI. In such examples, the mask may include a destination identifier (e.g., for the sidelink-connected UE or for the wireless node) and the RNTI of the wireless node. The destination identifier may indicate which device the grant is for. The base station may indicate that the grant of resources is for the wireless node by including an identifier (e.g., eight zeros) in the DCI or new mask, or by refraining from adding the destination ID to the mask. In some examples, the base station may transmit the grant of resources during a search space associated with the wireless node or UE for which the grant of resources pertains. For each receiver, the base station may configure different offsets from the search space of the wireless node.

In some examples, the shared RNTI is the RNTI of the sidelink-connected UE. In such examples, the base station may indicate, to the wireless node, all RNTIs of connected UEs (e.g., S/As, other UEs, etc.). The base station may configure the wireless node with a specified control resource set (CORESET) and search space, may encode the grant of resources using the RNTI of the UE for which the grant is intended, and may transmit the grant of resources in the configured search space and CORESET. The base station may add a one-bit indicator to the DCI to indicate which node the grant of resources is for (e.g., the wireless node or a UE). The base station may add a CRC mask with the destination identifier of the UE which the grant of resources is for.

Aspects of the disclosure are initially described in the context of wireless communications systems. Aspects of the disclosure are further illustrated by and described with reference to wireless communications systems, resource configurations, timelines, and process flows. Aspects of the disclosure are further illustrated by and described with reference to apparatus diagrams, system diagrams, and flowcharts that relate to signaling for base station-controlled sidelink grants.

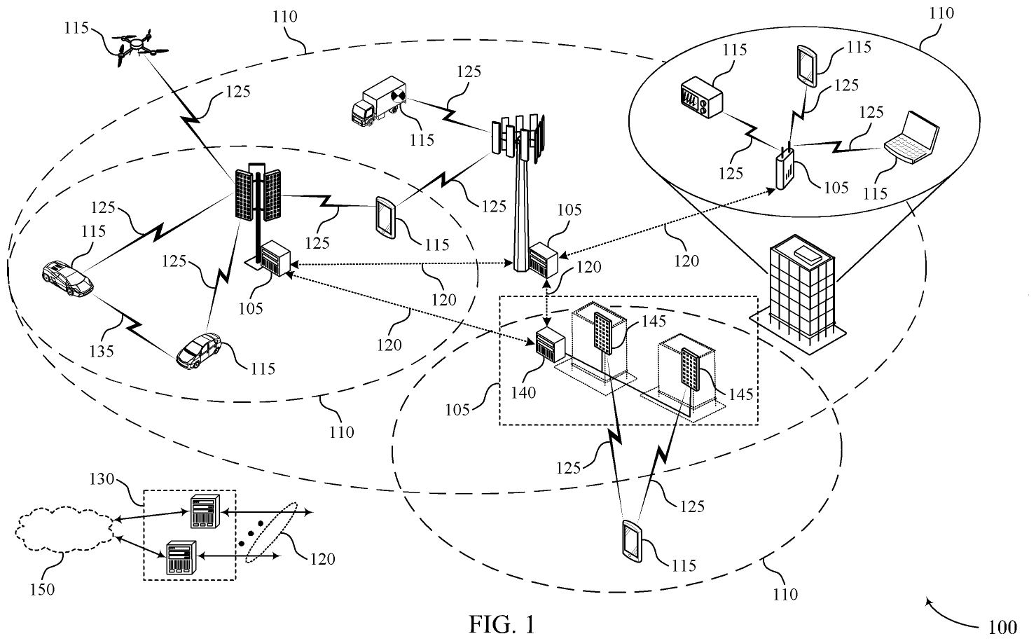

FIG. 1 illustrates an example of a wireless communications system 100 that supports signaling for base station-controlled sidelink grants in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

In some examples, one or more components of the wireless communications system 100 may operate as or be referred to as a network node. As used herein, a network node may refer to any UE 115, base station 105, entity of a core network 130, apparatus, device, or computing system configured to perform any techniques described herein. For example, a network node may be a UE 115. As another example, a network node may be a base station 105. As another example, a first network node may be configured to communicate with a second network node or a third network node. In one aspect of this example, the first network node may be a UE 115, the second network node may be a base station 105, and the third network node may be a UE 115. In another aspect of this example, the first network node may be a UE 115, the second network node may be a base station 105, and the third network node may be a base station 105. In yet other aspects of this example, the first, second, and third network nodes may be different. Similarly, reference to a UE 115, a base station 105, an apparatus, a device, or a computing system may include disclosure of the UE 115, base station 105, apparatus, device, or computing system being a network node. For example, disclosure that a UE 115 is configured to receive information from a base station 105 also discloses that a first network node is configured to receive information from a second network node. In this example, consistent with this disclosure, the first network node may refer to a first UE 115, a first base station 105, a first apparatus, a first device, or a first computing system configured to receive the information; and the second network node may refer to a second UE 115, a second base station 105, a second apparatus, a second device, or a second computing system.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

As described herein, a base station 105 may encode a grant of sidelink resources for a wireless device (e.g., for a wireless node or for another UE 115 that is connected to the wireless node) using a shared random network temporary identifier (RNTI). The shared RNTI may be the RNTI of the wireless node, or of the receiving UE 115 that is in sidelink communications with the wireless node. For example, the base station 105 may transmit a DCI message that includes the grant of resources on a search space for the wireless node (e.g., the PLC, central node, UE 115, etc.), and may encode the grant using the RNTI of the wireless node. The RNTI may be shared by the wireless node and other UEs 115 in sidelink communication with the wireless node. In this way, the wireless node may determine that the grant is for either it or one of the connected devices. The base station 105 may indicate that the grant is for one of the wireless node or a sidelink-connected UE 115 in a field in the DCI. In some examples, the base station 105 may indicate that the grant is for the wireless node or the sidelink-connected UE 115 using a new mask for the cyclic redundancy check (CRC) value for the DCI. In such examples, the mask may include a destination identifier (e.g., for the sidelink-connected UE 115 or for the wireless node) and the RNTI of the wireless node. The destination identifier may indicate which device the grant is for. The base station 105 may indicate that the grant of resources is for the wireless node by including an identifier (e.g., eight zeros) in the DCI or new mask, or by refraining from adding the destination ID to the mask. In some examples, the base station 105 may transmit the grant of resources during a search space associated with the wireless node or UE 115 for which the grant of resources pertains. For each receiver, the base station 105 may configure different offsets from the search space of the wireless node.

In some examples, the shared RNTI is the RNTI of the sidelink-connected UE 115. In such examples, the base station 105 may indicate, to the wireless node, all RNTIs of connected UEs 115 (e.g., S/As, other UEs 115, etc.). The base station 105 may configure the wireless node with a specified control resource set (CORESET) and search space, may encode the grant of resources using the RNTI of the UE 115 for which the grant is intended, and may transmit the grant of resources in the configured search space and CORESET. The base station 105 may add a one-bit indicator to the DCI to indicate which node the grant of resources is for (e.g., the wireless node or a UE 115). The base station 105 may add a CRC mask with the destination identifier of the UE 115 which the grant of resources is for.

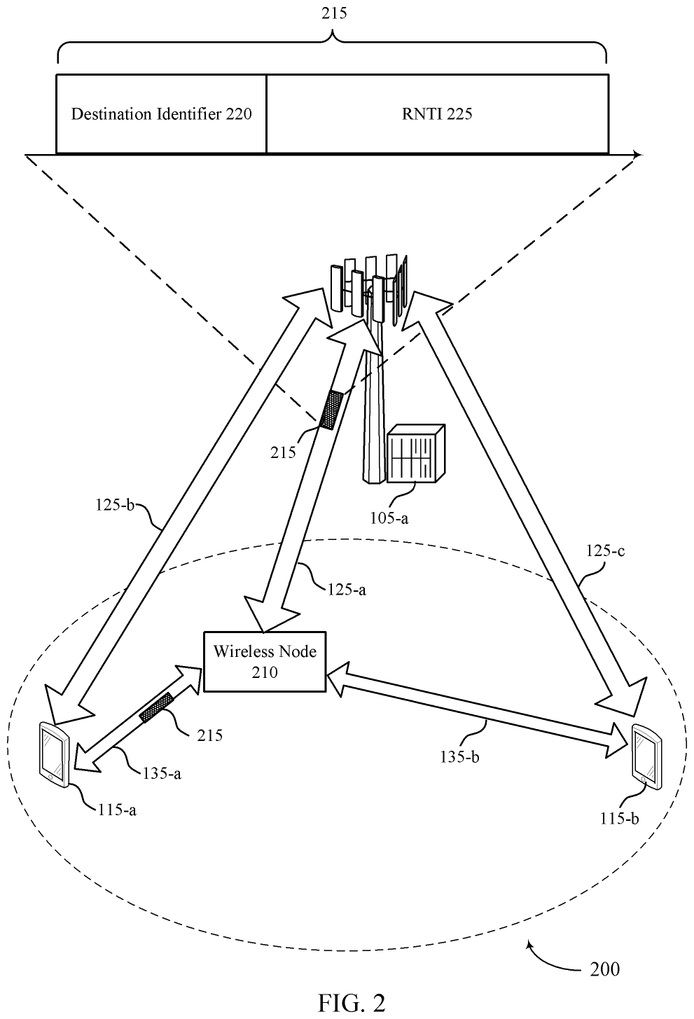

FIG. 2 illustrates an example of a wireless communications system 200 that supports signaling for base station-controlled sidelink grants in accordance with aspects of the present disclosure. Wireless communications system 200 may include a base station 105-a, a wireless node 210, and one or more UEs 115 (e.g., a UE 115-a and a UE 115-b), which may be examples of corresponding devices described with reference to FIG. 1. Techniques described herein may be applicable to any wireless communications system. In some examples, wireless communications system 200 may be an example of an industrial internet of things (IIoT) deployment. In such examples, the wireless node 210 may be an example of a programmable logic controller (PLC), and the UEs 115 may be examples of sensor/actuators (S/As).

Some examples of an IIoT deployment may support mission-critical traffic. Mission-critical traffic may be deterministic and periodicity. For example, wireless communications system 200 may support cyclic exchanges between wireless node 210 (e.g., the PLC) and a number of UEs 115 (e.g., the SAs). Such signaling may include small application-layer payloads (e.g., 40-256 bytes). Because of such smaller application-layer payloads and various headers, it may be beneficial to reduce overhead. Additionally, or alternatively, signaling in the IIoT deployment may satisfy stringent latency and reliability requirements (e.g., such that latency is about equal to 1-2 ms with a reliability of about 10⁶. In such examples, both data channels and control channels may be designated to meet such overall reliability requirements. In some examples, the IIoT may support a large number of UEs 115 per wireless node 210 (e.g., a large number of S/As per PLC). For instance, an IIoT may support a ratio of 20 to 50 S/As per PLC. The IIoT may support a large number of PLCs (for example, 100 to 1,00 PLCs, each PLC corresponding to 20 or more SAs).

In some examples, the wireless communications system 200 may support wireless PLC connectivity, which may significantly reduce reconfiguration costs for the IIoT (e.g., on a factory floor). For example, the wireless communications system 200 may support a star deployment. In such examples, each wireless PLC may communicate with a base station 105 via a Uu interface, and may communicate with S/As via a PC5 interface. For instance, the wireless node 210 (e.g., which may be an example of a PLC) may communicate with the base station 105-a via bidirectional communication link 125-a (e.g., a Uu communication link), and may communicate with the UE 115-a via bidirectional communication link 135-a (e.g., a PC5 communication link on a sidelink channel), and may communicate with the UE 115-b via bidirectional communication link 135-b (e.g., a PC5 communication link on a sidelink channel). In some examples, the UE 115-a may be in communication with the base station 105-a via bidirectional communication link 125-b, and the UE 115-b may also be in communication with the base station 105-a via bidirectional communication link 125-c. However, the UEs 115 may not be in in direct communication with each other. In some examples of an IIoT deployment, PLCs may be located close to machinery (e.g., the wireless node 210 may be located close to the UEs 115), and the base station 105-a may ceiling-mounted in a factory.

In some examples of the wireless communications system 200, where a wireless node 210 is connected to multiple UEs 115 (e.g., a PLC connected to multiple SAs), the base station 105-a may schedule resources for each UE 115 through the wireless node 210. For example, the base station 105-a may allocate one or more resources (e.g., time resources, frequency resources, spatial resources, or the like) to a UE 115, such as the UE 115-a. The allocated resources may be for communicating with the wireless node 210 (e.g., via the sidelink channel) or for communicating with the base station 105-a (e.g., via the Uu interface), or a combination thereof. The base station 105-a may transmit a grant 215 to the wireless node 210. The grant may be, for example, a DCI message indicating the allocated resources. However, without techniques described herein, the wireless node 210 may not be able to determine whether the grant of resources is directed to the wireless node 210 or a UE 115. Further, if the grant 215 is for one of the UEs 115 that is connected to the wireless node 210, then the wireless node 210 may not be able to determine which of the connected UEs 115 the grant 215 is for. In such examples, the grant 215 may not reach the intended recipient, resulting in failed transmissions, unutilized resources, decreased system efficiency, increased system latency, and decreased user experience. Similar issues may arrive outside of an IIoT deployment. For instance, the wireless node 210 may be a UE 115, a center node or a client-premises equipment (CPE), or the like, which is connected with multiple terminals. In such examples, if the base station 105-a transmits the grant 215 to the center node, the center node may not be able to determine whether the grant 215 is for the center node or a connected terminal.

In some examples, the base station 105-a may distinguish a grant 215 that is for a wireless node 210 from a grant 215 that is for a UE 115 by using a link-based radio network temporary identifier (RNTI). However, use of link-based RNTIs to indicate the intended recipient of a grant 215 may result in a large number of RNTIs, each of which may be defined or signaled among various wireless devices (e.g., configured at the wireless node 210 for at least each connected or potentially connected UE 115). This may result in an increase in signaling overhead, excessive use of device memory, or the like.

As described herein, the base station 105-a may indicate, to the wireless node 210, the intended recipient of a grant 215 via a destination identifier and an RNTI. Although illustrated and described with reference to wireless communications system 200 (e.g., which may be an example of an IIoT deployment, a star topology, or the like), techniques described herein may be applied to any wireless communications system, such as a sidelink deployment in which a sidelink UE 115 communicates with one or more sidelink UEs in a star topology or any other topology.

In some examples, the wireless node 210 may indicate an intended recipient for a grant 215 by using a destination identifier for the intended recipient and an RNTI associated with the wireless node 210. For instance, the wireless node 210 may be connected with multiple UEs 115 (e.g., the UE 115-a and the UE 115-b). The base station 105-a may transmit a grant 215. The grant 215 may indicate resources on which the wireless node 210 is to communicate, or may indicate resources on which a connected UE 115 is to communicate. The base station 105-a may transmit the grant 215 on a search space in a control resource set (coreset) allocated for the wireless node 210. The base station 105-a may scramble the grant 215 using the RNTI associated with the wireless node 210.

In some examples, the base station 105-a may include, in a dedicated field of the DCI message including the grant 215, a destination identifier associated with the intended recipient of the grant 215. For instance, if the grant 215 allocates resources on which the UE 115-a is to communicate, the base station 105-a may include a destination identifier (e.g., a device identifier for the UE 115-a) in a field of the DCI message. The destination identifier may indicate that the contents of the DCI message (e.g., the grant 215) is for the UE 115-a. In such examples, the wireless node 210 may forward the grant 215 to the UE 115-a (e.g., via the link 135-a on the sidelink channel). If the grant 215 allocates resources on which the wireless node 210 is to communicate, then the base station 105-a may include a destination identifier (e.g., a device identifier the wireless node 210) in a field of the DCI message. In some examples, the destination identifier may be a self-identification (e.g., a set of zeros, such as eight bits set to zero).

In some examples, the base station 105-a may add a mask to a cyclic redundancy check (CRC) for the DCI message. The mask added to the CRC may include a destination identifier 220. For example, the base station 105-a may encode the DCI message using an RNTI 225 and the destination identifier 220. The RNTI 225 may be a 16-bit RNTI, and the destination identifier may be an 8-bit destination identifier. If the destination identifier 220 indicates the UE 115-a, then the wireless node 210 may forward the grant 215 to the UE 115-a (e.g., via the link 135-a on the sidelink channel).

If the grant 215 allocates resources on which the wireless node 210 is to communicate, then the base station 105-a may add a mask to the CRC including a destination identifier 220 (e.g., a device identifier the wireless node 210). In some examples, the destination identifier 220 may be a self-identification (e.g., a set of zeros, such as eight bits set to zero). In some examples, if the grant 215 allocates resources on which the wireless node 210 is to communicate, then the base station 105-a may refrain from adding the mask with the destination identifier to the CRC in addition to the RNTI. For instance, the base station 105-a may encode the DCI message including the grant 215 using the RNTI associated with the wireless node 210. If the wireless node 210 decodes the message using its own RNTI (e.g., but not a destination identifier), then the wireless node 210 may not forward the grant 215 to a UE 115, and may instead communicate using the granted resources.

In some examples, the base station 105-a may encode the grant 215 using the RNTI of the intended recipient (e.g., an RNTI associated with a UE 115). For instance, the wireless node 210 may share the RNTI of one or more connected UEs 115. The base station 105-a may transmit, to the wireless node 210, an indication of the RNTIs of each connected UE 115 (e.g., an RNTI for the UE 115-a and an RNTI for the UE 115-b). In some examples, the wireless node 210 may request the list of RNTIs from the base station 105-a, or may provide a list of connected UEs 115 to the base station 105-a, and the base station 105-a may provide the RNTIs in response to the request or the provided list, or the like. In some examples, the UEs 115 may report their connected status (e.g., whether they are connected to the wireless node 210) to the base station 105-a, and the base station 105-a may transmit the list of RNTIs to the wireless node 210 based thereon. The wireless node 210 may attempt to decode the grant 215 using the received RNTIs.

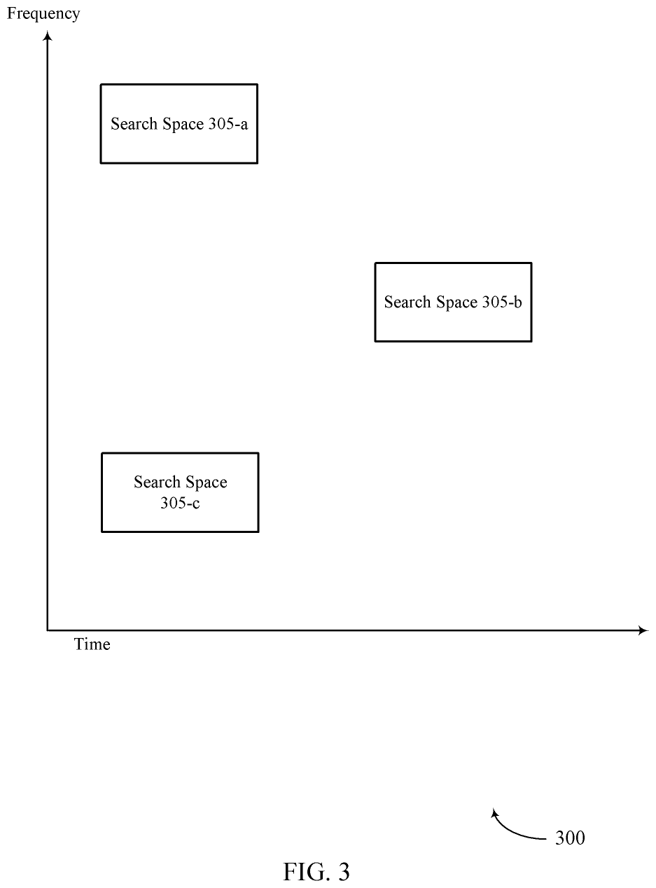

The base station may configure a coreset and search space (e.g., a PLC-specific coreset and search space, such as search space 305-a described with reference to FIG. 3) for receiving and decoding grants 215, which may be for one or more UEs 115. For example, the base station 105-a may configure the wireless node 210 with a search space in which to decode the grant 215. The wireless node 210 may perform blind decoding in the configured search space using the list of RNTIs. The wireless node 210 may successfully decode the grant 215 using one of the RNTIs. For example, the grant of resources may be associated with the UE 115-a (e.g., for communications between the wireless node 210 and the UE 115-a). In such examples, the wireless node 210 may attempt to decode the grant 215 using the RNTI associated with the UE 115-b and fail to decode the grant 215, but may attempt to decode the grant using the RNTI associated with the UE 115-a and succeed in decoding the grant 215.

Having successfully decoded the grant 215 using one of the list of RNTIs, the wireless node 210 may determine whether the grant 215 is for the wireless node 210 or for the UE 115-a. In some examples, the base station 105-a may include, in a DCI message including the grant 215, an indication of which node for which the contents of the grant 215 are intended. For example, the DCI message may include a flag (e.g., a one-bit flag). The one-bit flag may indicate whether the grant 405 is for the wireless node 210 or for the UE 115-a. For instance, if the bit is set to 1, then the grant 405 may be for the wireless node 210, and if the bit is set to 0, then the grant 405 may be for the UE 115-a. In such examples, if the bit is set to 0, then the wireless node 210 may forward the grant 405 to the UE 115-a. In some examples, the base station 105-a may add a mask to the CRC with a destination identifier 220 in addition to the RNTI 225. The destination identifier 220 may indicate whether the content of the grant 215 is for the wireless node 210 or the UE 115-a. For instance, if the destination identifier 220 includes a set of bits (e.g., 8 bits), then if the bits are set to zeros then the mask may indicate that the content of the grant 215 is for the wireless node 210, while if the bits are set to ones then the mask may indicate that the content of the grant 215 is for the UE 115-a.

In some examples, the base station 105-a may also indicate the search space and coreset of the wireless node 210 (e.g., the coreset and search space configured for receiving and decoding the grant 215 using the list of RNTIs) to the connected UEs 115. For instance, the base station 105-a may configure the UE 115-a and the UE 115-b with the coreset and search space. This may improve reliability of control signaling reception. For instance, the base station 105-a may transmit the grant 215 on at the search space of the coreset, as configured at both the wireless node 210 and the UEs 115. The UE 115-b may attempt to decode the grant 215 using its own RNTI. When the decoding fails, the UE 115-b may determine that the grant 215 is not for the UE 115-b. The UE 115-a may attempt to decode the grant 215 using its own RNTI, and may successfully decode the grant 215. The UE 115-a may determine that the grant is for the UE 115-a, and may communicate (e.g., with the wireless node 210 or the base station 105-a) accordingly. In such examples, even if the wireless node 210 fails to successfully decode the wireless node 210, or to forward the grant 215 to the UE 115-a, the UE 115-a may still receive the grant 215, and communicate according to the grant 215. If both the wireless node 210 and the UE 115-a are configured with the search space and coreset for receiving the grant 215, then the likelihood of the UE 115-a successfully receiving the grant 215 (e.g., directly from the base station 105-a or indirectly from the wireless node 210) may be increased.

In some examples, the base station 105-a may configure the wireless node 210 with one or more search spaces and coresets for respective UEs 115 (e.g., the search space 305-b and the search space 305-c, respectively, as described with reference to FIG. 3). The wireless node 210 may share the search spaces and coresets with the UEs 115. In such examples, the wireless node 210 may monitor each search space (e.g., one for each UE 115). The base station 105-a may transmit the grant 215, for the UE 115-a, via the search space and coreset. The wireless node 210 may monitor a search space and coreset for the UE 115-b, and may also monitor a search space and coreset for the UE 115-a. The UE 115-a may receive the grant 215. Because the wireless node 210 receives and decodes the grant 215 via the coreset and search space associated with the UE 115-a, the wireless node 210 may determine that the grant 215 is for the UE 115-a. Because both the wireless node 210 and the UE 115-a are configured with the search space and coreset for receiving the grant 215, then the likelihood of the UE 115-a successfully receiving the grant 215 (e.g., directly from the base station 105-a or indirectly from the wireless node 210) may be increased.

FIG. 3 illustrates an example of a resource configuration 300 that supports signaling for base station-controlled sidelink grants in accordance with aspects of the present disclosure. Resource configuration 300 may be utilized by or implemented by one or more wireless devices, such as a base station 105-a, a wireless node 210, and one or more UEs 115 (e.g., the UE 115-a and the UE 115-b), which may be examples of corresponding devices described with reference to FIG. 2.

In some examples, the base station 105-a may configure one or more wireless devices with search spaces and coresets. For instance, the base station 105-a may configure the wireless node 210 with search space 305-a (e.g., and a respective coreset), may configure the UE 115-a with a search space 305-b (e.g., and a respective coreset), may configure the UE 115-b with a search space 305-c (e.g., and a respective coreset), or any combination thereof.

In some examples, as described in greater detail with reference to FIG. 2, the base station 105-a may configure the wireless node 210 with a search space and coreset, and may further configure the wireless node 210 with a list of RNTIs for respective connected UEs 115 (e.g., a first RNTI for the UE 115-a and a second RNTI for the UE 115-b). The wireless node 210 may perform blind decoding in the search space 305-a using each RNTI in the list of RNTIs. For a grant 215 intended for the UE 115-a, the wireless node 210 may successfully decode the grant 215 using the first RNTI for the UE 115-a. For a grant 215 intended for the UE 115-b, the wireless node 210 may successfully decode the grant 215 using the second RNTI. The search space 305-a and corresponding search space may be periodic, and the wireless node 210 may monitor the search space 305-a at each periodic instance by attempting to decode control signaling using each RNTI in the list of RNTIs. Upon successfully decoding a grant 215 using the RNTI for the UE 115-a on the search space 305-a, the wireless node 210 may determine whether the grant 215 is for the wireless node 210 or the UE 115-a (e.g., based on a one-bit flag set to 1 or 0, or based on a mask added to the CRC encoding, where the mask includes a device identifier for the UE 115-a or the wireless node 210). If the wireless node 210 successfully decodes the grant 215 and determines that the grant 215 is for the UE 115-a, then the wireless node 210 may forward the received grant to the UE 115-a.

In some examples, as described in greater detail with reference to FIG. 2, wireless node 210 (e.g., a PLC) may share a CORESET and search spaces 305 with one or more UEs 115 (e.g., the UE 115-a and the UE 115-b, which may be examples of S/As). For instance, the wireless node 210 may identify (e.g., based at least in part on an indication received from the base station 105) search spaces 305 for each connected UE 115 (e.g., the search space 305-b and corresponding coreset for the UE 115-b and the search space 305-c and the corresponding coreset for the UE 115-b). In such examples, the base station 105-a may transmit a grant 215 for the UE 115-a via the search space 305-b, or may transmit a grant 215 for the UE 115-b via the search space 305-c. The wireless node 210 may monitor each of the configured coresets, and may perform blind decoding using the RNTI associated with a respective UE 115 (e.g., the first RNTI for the UE 115-a for the search space 305-a, and the second RNTI for the UE 115-b for the search space 305-b). If the grant 215 is intended for the UE 115-a, then the base station 105-a may transmit the grant 215 in the search space 305-b. Both the UE 115-a and the wireless node 210 may monitor the search space 305-b for the grant 215 using the RNTI for the UE 115-a, which may increase the reliability of the control signaling. If the wireless node 210 successfully decodes the grant 215 in search space 305-b, then the wireless node 210 may forward the received grant to the UE 115-a. If the grant 215 is for the wireless node 210, then the base station 105-a may transmit the grant 215 via the search space 305-a. In such examples, the wireless node 210 may periodically monitor its own search space 305-a and coreset, and may further periodically monitor search spaces 305 and coresets for each connected UE 115.

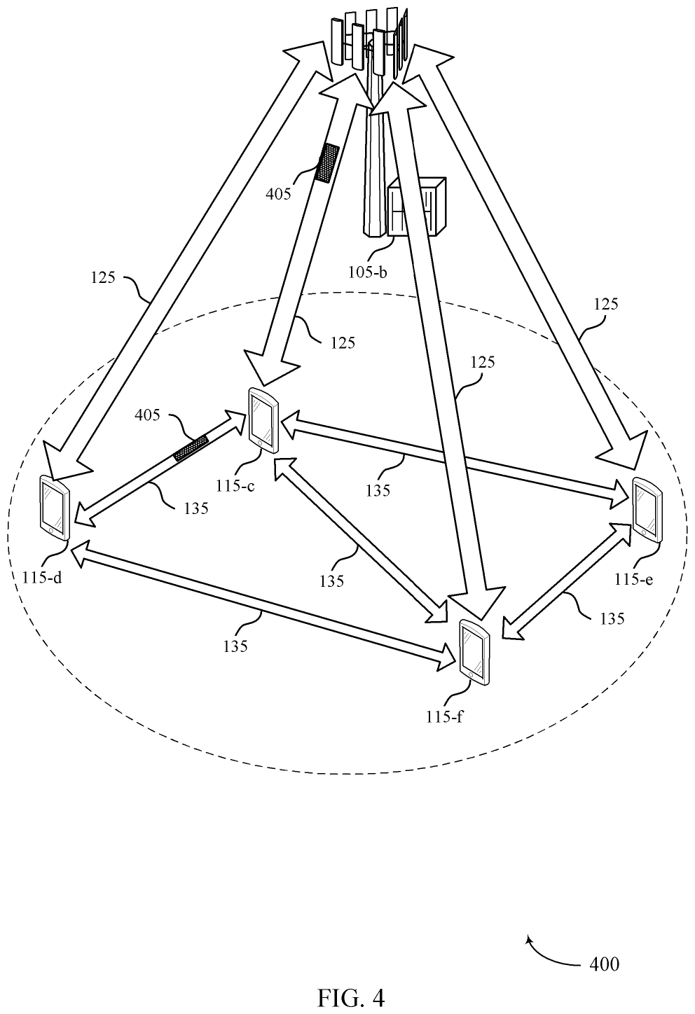

FIG. 4 illustrates an example of a wireless communications system 400 that supports signaling for base station-controlled sidelink grants in accordance with aspects of the present disclosure. The wireless communications system 400 may include a base station 105-b, and one or more UEs 115 (e.g., a UE 115-c, a UE 115-d, a UE 115-e, and a UE 115-f), which may be examples of corresponding devices described with reference to FIGS. 1-3. The base station 105-b may communicate with the UEs 115 via wireless communications links 125 (e.g., via a Uu interface). In some examples, the UEs 115 may communicate with each other via wireless communications links 135 (e.g., sidelink communications via a PC5 interface). In some examples, the wireless communications system 400 may support techniques described for an IIoT with reference to FIGS. 1-3. In some examples, one UE 115 may assist another UE 115 to communicate with the base station 105-b to support coverage enhancements. For instance, the UE 115-c may be connected to the base station 105-b, and may also maintain a sidelink connection with the UE 115-d. The UE 115-d may be located at the edge of coverage area 110-b (e.g., or outside of coverage area 110-b), and may therefore not have a reliable connection with the base station 105-b. The UE 115-c may also assist any other UEs 115 that do not have a reliable connection with the base station 105-b (e.g., due to interference, obstructions between devices or along a communications path, mobility of a UE 115, or the like). Additionally, or alternatively, coordination between UEs 115 (e.g., a UE 115 assisting another UE 115 to communicate with the base station 105-b) may improve reliability of communications in cases in which two or more connected UEs 115 can receive the same information.

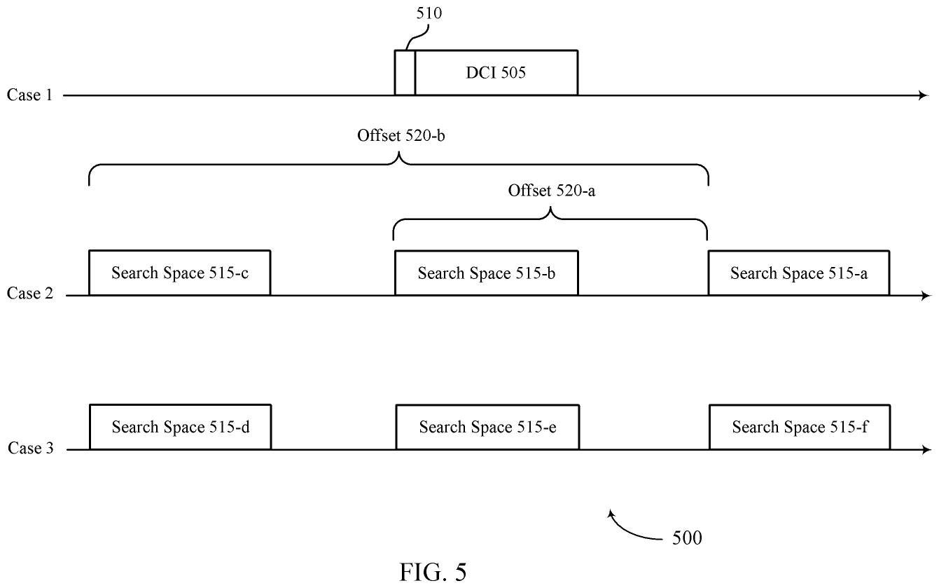

In some examples, as described with reference to FIG. 5, the base station 105-b may transmit a grant 405 to the UE 115-c. However, it may not be clear which pair of UEs 115 the grant 405 is for, or which of a pair of UEs 115 is to transmit and which is to receive. A receiving UE 115 may determine whether the grant 405 is for the UE 115-c or for another UE 115 based at least in part on a shared RNTI with which the grant 405 was encoded by the base station 105-b.

In some examples, the base station 105-b may utilize an RNTI for a transmitting UE 115 to indicate an intended recipient of the grant 405. For example, the base station 105-b may generate the grant 405, which may allocate sidelink resources for the UE 115-c to transmit sidelink signaling to the UE 115-d. In such examples, the base station 105-b may encode (e.g., scramble) the DCI message including the grant 405 with the RNTI of the UE 115-d. The UE 115-c may receive and decode the grant, and may determine that the grant is for sidelink resources on which to transmit sidelink signaling to the UE 115-d. For example, the DCI message may include an identifier field, which may indicate that the grant 405 is for the UE 115-c to transmit signaling to the UE 115-d.

In some examples, as described in greater detail with reference to FIG. 5, the base station 105-b may configure multiple search spaces at different offsets. That is, the UE 115-c may be configured with its own search space and coreset, and may further be configured with a search space and coreset for each respective connected UE 115. Each respective search space may be at an offset from the search space and coreset of the UE 115-c. Thus, the UE 115-c may receive the grant 405 at a search space that is a configured offset away from its own search space. The UE 115-c may decode the grant using its own RNTI, but may determine that the grant is for sidelink resources on which to communicate with the UE 115-d based on the search space in which the grant 405 was received. In such examples, the UE 115-c may transmit sidelink signaling to the UE 115-d using the sidelink resources indicated in the grant 405 (e.g., and may further transmit the sidelink signaling using a beam directed toward the UE 115-d based on determining that the UE 115-d is the intended recipient of the sidelink signaling). In some examples, the UE 115-c may forward the received grant 405 to the UE 115-d. The UE 115-d may receive the grant 405 from the UE 115-c, and may monitor for sidelink signaling from the UE 115-c based at least in part on having received the grant 405.

In some examples, as described in greater detail with reference to FIG. 5, the base station 105-c may add a mask to the CRC of the DCI message carrying the grant 405. For example, as described in greater detail with reference to FIGS. 2-3, the base station 105-c may encode the DCI message carrying the grant 405 using the RNTI of the transmitting UE (e.g., the UE 115-c) and may further encode the DCI message using a destination identifier associated with the receiving UE 115 (e.g., the UE 115-d). In such examples, the base station 105-b apply a mask (e.g., an 8-bit device identifier) for the receiving UE 115-d.

In some examples, to facilitate techniques described with reference to FIG. 4, the base station 105-b may transmit, to one or more UEs 115 (e.g., a central node such as the UE 115-c, or to all connected UEs 115), a list of RNTIs. The list of RNTIs may include an RNTI for each UE 115 connected to a particular UE 115 (e.g., an RNTI for each of the UE 115-e, the UE 115-f, and the UE 115-d). In some examples, the base station 105-b may transmit, to the UE 115-c, an indication of destination identifiers for connected UEs, which the UE 115-c may use to decode a received grant 405 and determine the intended recipient of sidelink signaling from the UE 115-c based on the grant 405.

In some examples, to improve reliability, receiving UEs 115 may also decode grants 405. For example, the base station 105-b may inform multiple UEs 115 (e.g., UEs 115 that are connected to a transmitting UE 115-c) of search space configurations, cell-specific RNTIs (C-RNTIs) for transmitting UEs 115 (e.g., the C-RNTI for the UE 115-c), or a combination thereof. For instance, the base station 105-b may indicate, to the UE 115-d (e.g., and other UEs 115) a C-RNTI for the UE 115-c, search spaces in which the base station 105-b will transmit respective grants 405, or the like. The UE 115-d may then monitor a search space associated with the UE 115-d, and may perform blind decoding using the RNTI of the UE 115-c. If the UE 115-d successfully decodes the grant 405 using the RNTI for the UE 115-c, then the UE 115-d may determine that the UE 115-c is to transmit sidelink signaling to the UE 115-d according to the grant 405. IN such examples, if the UE 115-d is out of coverage, or if the UE 115-c is out of coverage, the DCI message carrying the grant 405 may still be received (e.g., and forwarded to the other UE 115 of a transmitter and receiver pair of UEs 115).

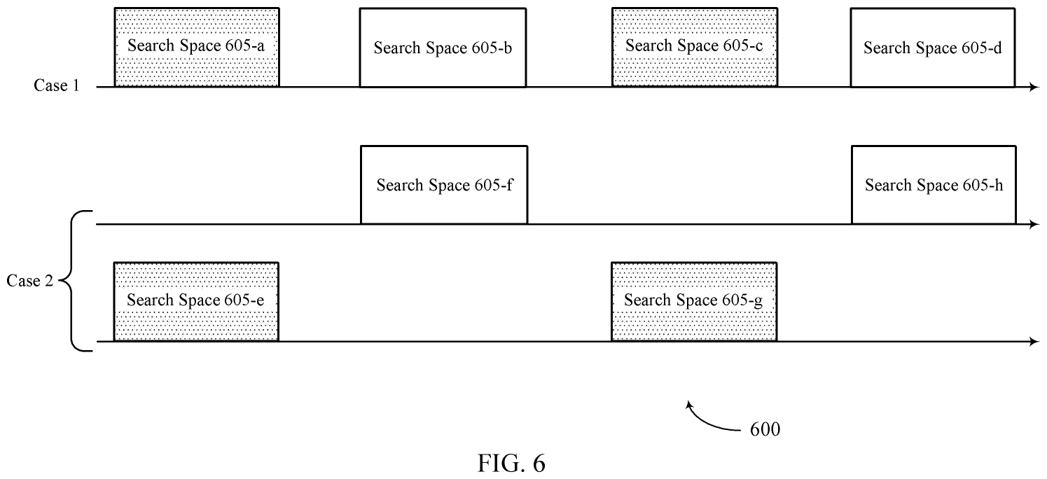

In some examples, as described with reference to FIG. 6, the base station 105-c may indicate the transmitting UE 115 and the receiving UE 115 for a grant 405 based at least in part on the RNTI for the receiving UE 115. In such examples, the base station 105-b may configure one or more UEs 115 (e.g., the UE 115-c) with an RNTI (e.g., a C-RNTI) for each connected node. For example, the base station 105-b may transmit, to the UE 115-c, an indication (e.g., a list) of C-RNTIs for one or more connected UEs 115 (e.g., the UE 115-d, the UE 115-e, and the UE 115-f, respectively). Similarly, the base station 105-b may configure the UE 115-f with the C-RNTIs for the UE 115-d, the UE 115-c, and the UE 115-e, respectively. The base station 105-b may configure the UE 115-d with C-RNTIs for the UE 115-c and the UE 115-f, respectively. The base station 105-b may configure the UE 115-e with C-RNTIs for the UE 115-c and the UE 115-f, respectively.

In some examples, the grant 405 may be for a link between the UE 115-c and the UE 115-d. For instance, the grant 405 may allocate resources on which the UE 115-c is to transmit sidelink signaling to the UE 115-d. In such examples, the base station 105-b may encode the grant 405 using the RNTI of the UE 115-d (e.g., the receiving UE 115), but may transmit the grant 405 to the UE 115-c (e.g., the transmitting UE 115). To facilitate such signaling, the base station may configure a receiver-based search space and coreset. For instance, the base station 105-b may transmit, a DCI message carrying the grant 405 via the search space and coreset for the UE 115-d. The base station 105-b may have configured the UEs 115 with search spaces and coresets for all configured UEs 115. In such examples, the UE 115-c may monitor its own search space and coreset, as well as a search space and coreset for the UE 115-d. The UE 115-c may decode the grant 405 using the RNTI of the UE 115-d in the search space for the UE 115-d. Additionally, the UE 115-f may be configured with the search space and coreset for the UE 115-d, and may monitor accordingly.

In some examples, the receiving UE 115-d may be connected to multiple UEs 115 (e.g., the UE 115-c and the UE 115-f). The UE 115-d may decode the grant 405 received via its own search space and coreset (e.g., or may receive the grant forwarded by the UE 115-c, or both). Having decoded the grant 405 using the RNTI for the UE 115-d, or having received the grant 405 in the search space and coreset for the UE 115-d, or both, the UE 115-d may determine that it is the intended recipient of sidelink signaling according to the grant. However, the UE 115-d may also need to determine which connected UE 115 is the transmitting UE 115 for the grant 405. In some examples, the base station 105-b may include, in a field of the DCI message carrying the grant 405, an identifier of the transmitting UE 115. For instance, the DCI message may include a device identifier or a source identifier for the UE 115-c, in which case the UE 115-d may monitor the allocated resources of grant 405 for sidelink signaling from the UE 115-c (e.g., the UE 115-d may direct a receive beam toward the UE 115-c). In some examples, as described with reference to case 1 of FIG. 5, the UE 115-d may determine the transmitting UE 115 based on configured time offsets for the UE 115-d and the UE 115-f to monitor for the grant 405. IN some examples, in addition to the RNTI, the base station 105-b may add a mask to the CRC with an identifier for the transmitting UE 115. The UE 115-d may decode the grant 405, and identify the device or source identifier indicating that the UE 115-c is to be the transmitting UE 115. In such examples, the UE 115-d may monitor the allocated resources of grant 405 for sidelink signaling from the UE 115-c (e.g., the UE 115-d may direct a receive beam toward the UE 115-c).

In some examples, as described in greater detail with reference to case 2 of FIG. 6, the base station may transmit the grant 405, encoded using the RNTI of the receiving UE 115, via transmitter-based search spaces and coresets. For example, the UE 115-d and the UE 115-f may be configured with different search spaces and coresets, such that either the UE 115-d or the UE 115-f could successfully decode the grant 405. In such examples, the base station 105-b may inform the UE 115-c of the search spaces and coreset configurations for the UE 115-d and the UE 115-f. In such examples, both the UE 115-c and the UE 115-d may successfully decode a grant for sidelink signaling from the UE 115-c to the UE 115-d, which may improve reliability.

FIG. 5 illustrates an example of a timeline 500 that supports signaling for base station-controlled sidelink grants in accordance with aspects of the present disclosure. Timeline 500 may implement aspects of or be implemented by one or more wireless devices, such as a base station 105-b, and one or more UEs 115 (e.g., the UE 115-c, the UE 115-d, the UE 115-e, and the UE 115-f), which may be examples of corresponding devices described with reference to FIGS. 1-4.

In some examples (e.g., case 1), as described in greater detail with reference to FIG. 4, a base station 105-b may transmit a grant 405 to a transmitting UE 115-c. A DCI message 505 carrying the grant 405 may include a field 510. The field 510 may indicate the receiving device (e.g., the UE 115-d for a case in which the grant 405 allocates resources on which the UE 115-c is to transmit sidelink signaling to the UE 115-d).

In some examples (e.g., case 2), as described in greater detail with reference to FIG. 4, a base station 105-b may configure different offsets from a search space and coreset of a transmitting UE 115-c. For example, the base station 105-b may configure the UE 115-c with its own search space 515-a and corresponding coreset. The base station 105-b may also configure the UE 115-c with a search space 515-b and corresponding coreset for the UE 115-d. The search space 515-b may be offset from the search space 515-c by offset 520-a. The base station 105-b may also configure the UE 115-c with a search space 515-c and corresponding coreset for the UE 115-e. The search space 515-c may be offset from the search space 515-c by offset 520-b. The UE 115-c may monitor the search space 515-c, the search space 515-b, and the search space 515-a. In some examples, the base station 105-b may encode the grant 405 using the RNTI of the UE 115-c (e.g., the transmitting UE 115-c). The UE 115-c may decode the grant 405 using its own RNTI, but may determine the intended recipient of the sidelink signaling according to the grant 405 based on the search space 515 in which the grant 405 is received. In some examples, the base station 105-b may encode the grant using the RNTI of the receiving UE 115. In such examples, the UE 115-c may perform blind decoding during search space 515-c using the RNTI for the UE 115-e, and may perform blind decoding during search space 515-b using the RNTI for the UE 115-d. The UE 115-c may perform blind decoding during search space 515-a using its own RNTI. If the UE 115-c successfully decodes the grant 405 during the search space 515-b, using the RNTI for the UE 115-d, then the UE 115-c may determine that the grant 405 is for a sidelink transmission from the UE 115-c to the UE 115-d. In some examples, the UE 115-c may forward the grant 405 to the UE 115-d. In some examples, the UE 115-c may communicate with the UE 115-d according to the grant 405. If the UE 115-c receives the grant 405 in its own search space 515-a, then the UE 115-c may determine that the grant 405 is for a transmission from another UE 115 to the UE 115-c.

In some examples (e.g., case 3), as described in greater detail with reference to FIG. 4, the base station 105-b may configure the UE 115-c with one or more search spaces 515 (e.g., the search space 515-d and corresponding coreset, the search space 515-e and corresponding coreset, and the search space 515-f and corresponding coreset, etc.). In some examples, the base station 105-b may also configure the UE 115-c with a list of RNTIs associated with connected UEs 115 (e.g., the UE 115-d, the UE 115-e, and the UE 115-f). In such examples, the UE 115-c may monitor for the grant 405 in each configured search space 515. In such examples, the UE 115-c may perform blind decoding in each search space 515 using each RNTI. The UE 115-c may determine the intended recipient of the sidelink signaling according to the grant 405 based on successfully decoding (e.g., descrambling) the grant 405 using a particular RNTI. That is, if the UE 115-c successfully decodes the grant 405 (e.g., in search space 515-e) using the RNTI for the UE 115-d, then the UE 115-c may determine that the grant 405 allocates sidelink resources on which the UE 115-c is to transmit sidelink signaling to the UE 115-d. In some examples, the UE 115-c may determine that the UE 115-c is to transmit the sidelink signaling to the UE 115-c based on a mask added to the CRC of the received grant 405.

FIG. 6 illustrates an example of a timeline 600 that supports signaling for base station-controlled sidelink grants in accordance with aspects of the present disclosure. Timeline 600 may implement aspects of or be implemented by one or more wireless devices, such as a base station 105-b, and one or more UEs 115 (e.g., the UE 115-c, the UE 115-d, the UE 115-e, and the UE 115-f), which may be examples of corresponding devices described with reference to FIGS. 1-5.

In some examples (e.g., case 1), as described with reference to FIG. 4, the base station 105-b may configure different time offsets during which UEs 115 (e.g., the UE 115-d and the UE 115-e are to monitor for the grant 405. For example, the base station 105-b may configure receiver-based search spaces and coresets (e.g., for the UE 115-c to monitor). The base station 105-b may configure the search space 605-a and the search space 605-c for the UE 115-e, and the search space 605-b and the search space 605-d for the UE 115-d. The search spaces 605 may be defined by an offset from a search space for the UE 115-c. The base station 105-b may configure the search spaces 605 for the UE 115-c, but may indicate the search spaces to the receiving UE 115-d and the UE 115-e, such that the receiving UEs 115 may also monitor for the grant 405. The UE 115-c may monitor each of the configured search spaces 605. Thus, the UE 115-c and the UE 115-e may monitor the search space 605-a and the search space 605-c, and the UE 115-c and the UE 115-d may monitor the search space 605-b and the search space 605-d.

In some examples (e.g., case 2), as described with reference to FIG. 4, the base station 105-b may configure transmitter-based search spaces and coresets (e.g., for the UE 115-d and the UE 115-e). Either the UE 115-d or the UE 115-e may be capable of decoding a grant 405 received in a search space. The Base station 105-b may configure the search spaces 605 for the receiving UEs 115. For example, the UE 115-d may only be aware of and monitor search space 605-e and search space 605-h, and the UE 115-e may only be aware of search space 605-e and search space 605-g. The base station 105-b may also configure the UE 115-c with the search spaces 605, such that the UE 115-c and the UE 115-d monitor search space 605-f and search space 605-h, and both the UE 115-c and the UE 115-e monitor search space 605-e and search space 605-g.

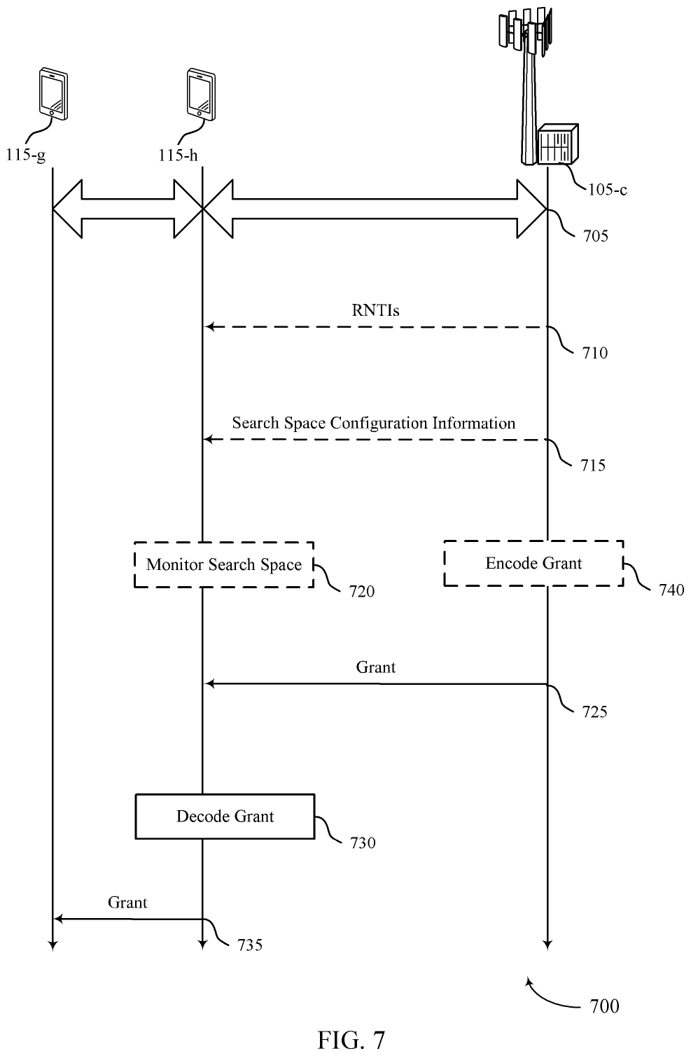

FIG. 7 illustrates an example of a process flow 700 that supports signaling for base station-controlled sidelink grants in accordance with aspects of the present disclosure. Process flow 700 may include a base station 105-c, and a UE 115-g and a UE 115-h, which may be examples of corresponding devices described with reference to FIGS. 1-6. For example, the UE 115-g may be a wireless node. The wireless node may be an example of a PLC, and the UE 115-h may be an example of an S/A (e.g., as described in an IIoT deployment with reference to FIGS. 2-3). In some examples, the base station 105-c, the UE 115-g and the UE 115-h may be deployed in a star topology or a non-star topology. In some examples, the wireless node may be an example of a UE 115 (e.g., a central node), and the UE 115-h may be an example of another sidelink UE 115 in a sidelink deployment.

At 705, the UE 115-h may communicate with the base station 105-c via a first wireless communication link (e.g., a Uu interface) and may communicate with the UE 115-g via a second wireless link (e.g., a PC5 interface). For example, the UE 115-h may establish a connection via a cellular network with the base station 105-c. The UE 115-h may establish a sidelink connection with the UE 115-g.

At 725, the base station 105-c may transmit, and the UE 115-h may receive, a grant of resources associated with the second wireless communication link (e.g., a sidelink grant). For example, the base station 105-c may transmit a DCI message including the grant of resources. The base station 105-c may encode the grant of resources using a shared RNTI (e.g., the RNTI for the UE 115-h, or an RNTI for the UE 115-g, as described herein). The shared RNTI may be shared by both the UE 115-h and the UE 115-g.

At 720, the UE 115-h may monitor a search space in a coreset for the grant of resources. At 730, the UE 115-h may decode the grant of resources. Based on the decoding, the UE 115-g may determine whether the grant of resources is for the UE 115-h or the UE 115-g.

If the UE 115-h determines that the grant of resources is for the UE 115-g, then the UE 115-g may forward the grant of resources to the UE 115-g at 735.

In some examples, at 720, the UE 115-h may monitor a search space of a coreset associated with the UE 115-h on the first wireless communication link for the DCI message that includes the grant of resources. For example, at 715, the base station 105-c may transmit search space configuration information indicating the search space for the UE 115-h. The UE 115-h may receive the DCI message, which may be encoded with the shared RNTI. The shared RNTI may be the RNTI for the UE 115-h.

The UE 115-h may determine, based on the monitoring, whether the grant of resources is for the UE 115-h or the UE 115-g. The DCI message may include a field that includes a destination identifier associated with the UE 115-g, which indicates that the grant of resources is for the UE 115-g. In some examples, the UE 115-h may decode the grant of resources at 730, which may include decoding a CRC associated with the grant of resources. For instance, at 740, the base station 105-c may encode the grant of resources, and may add a mask to the CRC. The UE 115-h may decode the CRC based on the RNTI for the UE 115-h and a device identifier for the UE 115-g, and may determine that the grant is for the UE 115-g based on the decoding.

In some examples, the grant of resources may be for the UE 115-h. For instance, at 725 the base station 105-c may transmit the grant of resources to the UE 115-h. The UE 115-h may identify (e.g., in a field of the DCI message carrying the grant) an identifier associated with the UE 115-h). The identifier may be, for example, a flag, or a string of bits set of a predefined or preconfigured value (e.g., a set of eight bits set to 0). In such examples, the UE 115-h may determine that the grant of resources is for the UE 115-h, and the UE 115-h may perform sidelink communications (e.g., with the UE 115-g or with another UE 115) using the sidelink resources allocated by the sidelink grant. In some examples, the UE 115-h may determine that the grant of resources is for the UE 115-h based on decoding the CRC of the DCI message carrying the grant of resources. For instance, the base station 105-c may encode the CRC of the DCI message at 740, and may include a mask (e.g., an 8-bit device identifier or the UE 115-h). The UE 115-h may decode the DCI message (e.g., using its own RNTI and the device identifier) and may further decode the CRC using the device identifier for the UE 115-h. The UE 115-h may then perform sidelink communications according to the grant. The base station 105-c may configure the UE 115-h with its RNTI, with one or more destination identifiers (e.g., for the UE 115-h, for the UE 115-h, or for a set of connected UEs 115). In some examples, the UEs 115 may exchange destination or device identifiers (e.g., via the sidelink connection at 705).

In some examples, at 710, the base station 105-c may transmit a set of RNTIs to the UE 115-h. The set of RNTIs may be associated with respective UEs 115 of a set of UEs 115 that includes the UE 115-g (e.g., a set of UEs 115 that are connected to the UE 115-h, the base station 105-c, or both). In such examples, the UE 115-h may monitor a search space (e.g., configured for the UE 115-h at 715) by performing blind decoding using each RNTI of the set of RNTIs. In such examples, the shared RNTI may be the RNTI of the UE 115-g. The UE 115-h may successfully decode the grant of resources using the RNTI of the UE 115-g. In some examples, the DCI message carrying the grant may also include a field (e.g., with a one-bit flag) indicating whether the successfully decode grant is for the UE 115-h or the UE 115-g. In some examples, the base station 105-c may encode the CRC of the grant of resources (e.g., at 740) using a destination identifier (e.g., for the UE 115-g or the UE 115-h) that indicates whether the grant of resources is for the UE 115-h or the UE 115-g.

In some examples, the base station 105-c may configure one or more search spaces and coresets for the UE 115-h to monitor. For example, at 715, the base station 105-c may transmit an indication of a search space associated with the UE 115-g. The UE 115-h may monitor the search space associated with the UE 115-g for the grant of resources at 720, and may receive the grant of resources at 725. In some examples, the search space configuration information may include one or more offset values. The UE 115-h may determine an offset between its own search space and a search space associated with the UE 115-g, and may perform the monitoring at 720 based on the offset values.

In some examples, at 715, the base station 105-c may configure both the UE 115-h and the UE 115-g to monitor one or more search spaces for the grant of resources. For instance, the base station 105-c may configure the UE 115-h with a transmitter-specific search space, and may also configure the UE 115-g to monitor the configured transmitter-specific search space. In some examples, the base station 105-c may configure receiver-specific search spaces (e.g., for the UE 115-g and one or more additional UEs 115 connected to the UE 115-h), and may also configure the UE 115-h to monitor the search spaces. In such cases, both the UE 115-h and the UE 115-g may monitor search spaces and coresets for control signaling including the grant of resources, which may increase reliability of the control signaling.

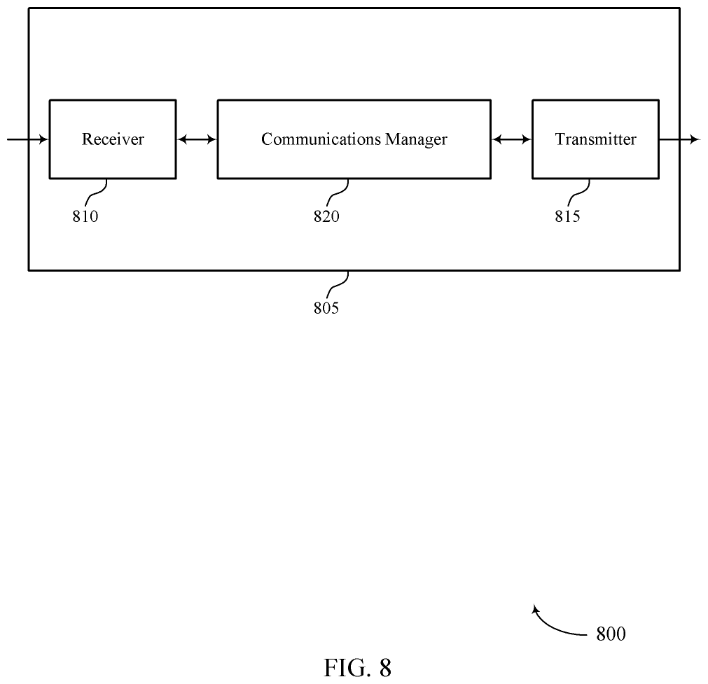

FIG. 8 shows a block diagram 800 of a device 805 that supports signaling for base station-controlled sidelink grants in accordance with aspects of the present disclosure. The device 805 may be an example of aspects of a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to signaling for base station-controlled sidelink grants). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to signaling for base station-controlled sidelink grants). In some examples, the transmitter 815 may be co-located with a receiver 810 in a transceiver module. The transmitter 815 may utilize a single antenna or a set of multiple antennas.

The communications manager 820, the receiver 810, the transmitter 815, or various combinations thereof or various components thereof may be examples of means for performing various aspects of signaling for base station-controlled sidelink grants as described herein. For example, the communications manager 820, the receiver 810, the transmitter 815, or various combinations or components thereof may support a method for performing one or more of the functions described herein.

In some examples, the communications manager 820, the receiver 810, the transmitter 815, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 820, the receiver 810, the transmitter 815, or various combinations or components thereof may be implemented in code (e.g., as communications management software or firmware) executed by a processor. If implemented in code executed by a processor, the functions of the communications manager 820, the receiver 810, the transmitter 815, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 820 may be configured to perform various operations (e.g., receiving, monitoring, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to receive information, transmit information, or perform various other operations as described herein.

The communications manager 820 may support wireless communications at a wireless node in accordance with examples as disclosed herein. For example, the communications manager 820 may be configured as or otherwise support a means for communicating with a base station via a first wireless communication link and with a UE via a second wireless communication link. The communications manager 820 may be configured as or otherwise support a means for receiving, from the base station via the first wireless communication link, a grant of resources associated with the second wireless communication link, where the grant of resources is encoded with a shared RNTI that is shared by both the wireless node and the UE. The communications manager 820 may be configured as or otherwise support a means for determining, based on the shared RNTI, that the grant of resources is for the UE. The communications manager 820 may be configured as or otherwise support a means for forwarding the grant to the UE.

By including or configuring the communications manager 820 in accordance with examples as described herein, the device 805 (e.g., a processor controlling or otherwise coupled to the receiver 810, the transmitter 815, the communications manager 820, or a combination thereof) may support techniques for sidelink communications resulting in more efficient use of available communication resources, improved reliability of communications, decreased latency, and improved user experience.

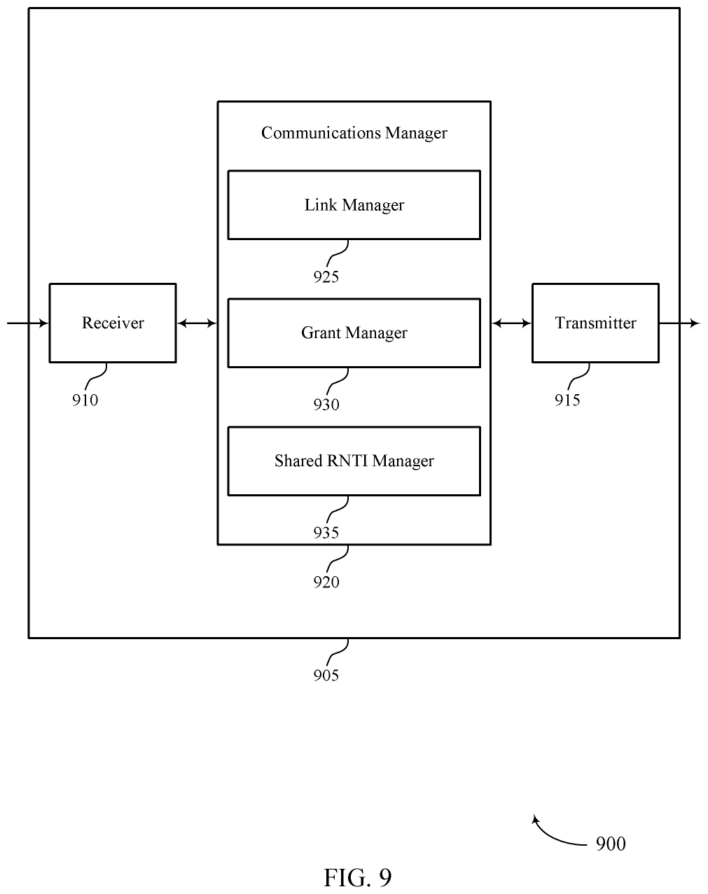

FIG. 9 shows a block diagram 900 of a device 905 that supports signaling for base station-controlled sidelink grants in accordance with aspects of the present disclosure. The device 905 may be an example of aspects of a device 805 or a UE 115 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to signaling for base station-controlled sidelink grants). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to signaling for base station-controlled sidelink grants). In some examples, the transmitter 915 may be co-located with a receiver 910 in a transceiver module. The transmitter 915 may utilize a single antenna or a set of multiple antennas.

The device 905, or various components thereof, may be an example of means for performing various aspects of signaling for base station-controlled sidelink grants as described herein. For example, the communications manager 920 may include a link manager 925, a grant manager 930, a shared RNTI manager 935, or any combination thereof. The communications manager 920 may be an example of aspects of a communications manager 820 as described herein. In some examples, the communications manager 920, or various components thereof, may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a wireless node in accordance with examples as disclosed herein. The link manager 925 may be configured as or otherwise support a means for communicating with a base station via a first wireless communication link and with a UE via a second wireless communication link. The grant manager 930 may be configured as or otherwise support a means for receiving, from the base station via the first wireless communication link, a grant of resources associated with the second wireless communication link, where the grant of resources is encoded with a shared RNTI that is shared by both the wireless node and the UE. The shared RNTI manager 935 may be configured as or otherwise support a means for determining, based on the shared RNTI, that the grant of resources is for the UE. The grant manager 930 may be configured as or otherwise support a means for forwarding the grant to the UE.

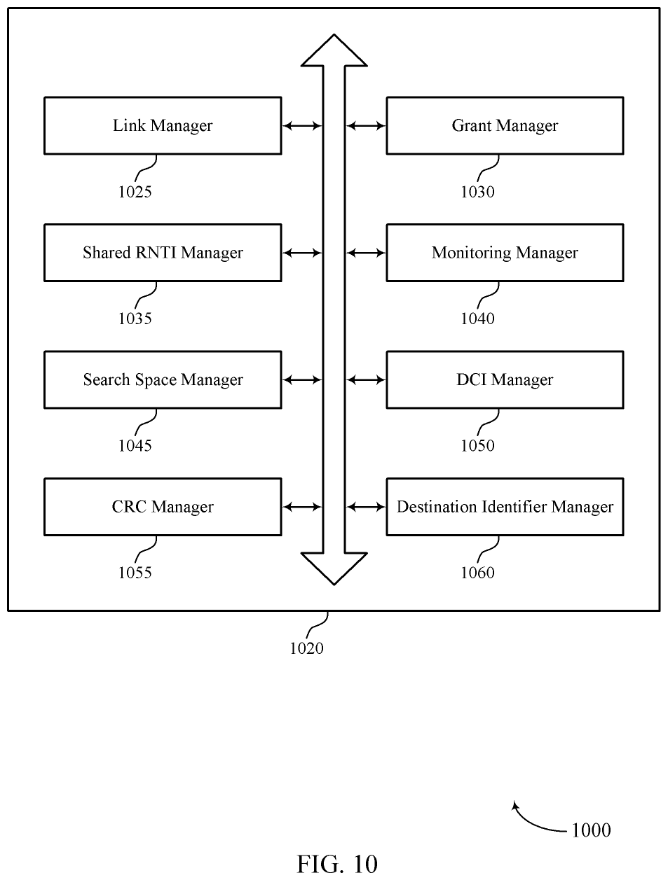

FIG. 10 shows a block diagram 1000 of a communications manager 1020 that supports signaling for base station-controlled sidelink grants in accordance with aspects of the present disclosure. The communications manager 1020 may be an example of aspects of a communications manager 820, a communications manager 920, or both, as described herein. The communications manager 1020, or various components thereof, may be an example of means for performing various aspects of signaling for base station-controlled sidelink grants as described herein. For example, the communications manager 1020 may include a link manager 1025, a grant manager 1030, a shared RNTI manager 1035, a monitoring manager 1040, a search space manager 1045, a DCI manager 1050, an CRC manager 1055, a destination identifier manager 1060, or any combination thereof. Each of these components may communicate, directly or indirectly, with one another (e.g., via one or more buses).

The communications manager 1020 may support wireless communications at a wireless node in accordance with examples as disclosed herein. The link manager 1025 may be configured as or otherwise support a means for communicating with a base station via a first wireless communication link and with a UE via a second wireless communication link. The grant manager 1030 may be configured as or otherwise support a means for receiving, from the base station via the first wireless communication link, a grant of resources associated with the second wireless communication link, where the grant of resources is encoded with a shared RNTI that is shared by both the wireless node and the UE. The shared RNTI manager 1035 may be configured as or otherwise support a means for determining, based on the shared RNTI, that the grant of resources is for the UE. In some examples, the grant manager 1030 may be configured as or otherwise support a means for forwarding the grant to the UE.

In some examples, the monitoring manager 1040 may be configured as or otherwise support a means for monitoring a search space of a control resource set associated with the wireless node on the first wireless communication link for a DCI message that includes the grant of resources, where the DCI message is encoded with the shared RNTI which is an identifier of the wireless node, and where receiving the grant of resources is based on the monitoring.

In some examples, the DCI manager 1050 may be configured as or otherwise support a means for receiving, in a field of the DCI message including the grant of resources, a destination identifier associated with the UE, where the determining is based on receiving the destination identifier.

In some examples, the CRC manager 1055 may be configured as or otherwise support a means for decoding a cyclic redundancy check associated with the grant of resources. In some examples, the shared RNTI manager 1035 may be configured as or otherwise support a means for identifying, based on the decoding, the shared RNTI which is the identifier of the wireless node and a destination identifier associated with the UE, where the determining is based on identifying the destination identifier.

In some examples, the grant manager 1030 may be configured as or otherwise support a means for receiving, from the base station via the first wireless communication link, a second grant of resources associated with the second wireless communication link, where the second grant of resources is encoded with a second shared RNTI that is shared by both the wireless node and the UE. In some examples, the destination identifier manager 1060 may be configured as or otherwise support a means for identifying, in the second grant of resources, an identifier associated with the wireless node. In some examples, the destination identifier manager 1060 may be configured as or otherwise support a means for determining, based on the second shared RNTI and the identifier associated with the wireless node, that the second grant of resources is for the wireless node. In some examples, the grant manager 1030 may be configured as or otherwise support a means for performing sidelink communications on the second wireless communication link according to the second grant of resources.

In some examples, the grant manager 1030 may be configured as or otherwise support a means for receiving, from the base station via the first wireless communication link, a second grant of resources associated with the second wireless communication link, where the second grant of resources is encoded with a second shared RNTI that is shared by both the wireless node and the UE. In some examples, the CRC manager 1055 may be configured as or otherwise support a means for decoding a cyclic redundancy check associated with the second grant of resources. In some examples, the grant manager 1030 may be configured as or otherwise support a means for determining, based on the second shared RNTI and an absence of an identifier associated with the UE, that the second grant of resources is for the wireless node. In some examples, the grant manager 1030 may be configured as or otherwise support a means for performing sidelink communications on the second wireless communication link according to the second grant of resources.

In some examples, the shared RNTI manager 1035 may be configured as or otherwise support a means for receiving, from the base station, an indication of a set of RNTIs associated with respective UEs of a set of UEs including the UE, where the set of RNTIs includes the shared RNTI. In some examples, the monitoring manager 1040 may be configured as or otherwise support a means for monitoring, using the shared RNTI based on receiving the indication of the set of RNTIs, a search space of a control resource set associated with the wireless node on the first wireless communication link for a DCI message that includes the grant of resources, where the DCI message is encoded with the shared RNTI which is an identifier of the UE.

In some examples, the DCI manager 1050 may be configured as or otherwise support a means for receiving, in a field of the DCI message including the grant of resources, a one-bit indication that the grant of resources is for the UE, where the determining is based on receiving the one-bit indication.

In some examples, the CRC manager 1055 may be configured as or otherwise support a means for decoding a cyclic redundancy check associated with the grant of resources. In some examples, the shared RNTI manager 1035 may be configured as or otherwise support a means for identifying, based on the decoding, the shared RNTI which is the identifier of the UE and a destination identifier associated with the UE, where the determining is based on identifying the destination identifier.

In some examples, the set of UEs includes respective UEs that are operating in a connected mode with the UE.

In some examples, the search space manager 1045 may be configured as or otherwise support a means for receiving, from the base station, an indication of a search space associated with the UE. In some examples, the search space manager 1045 may be configured as or otherwise support a means for monitoring the search space for the grant of resources, where the determining is based on the monitoring the search space.

In some examples, the search space manager 1045 may be configured as or otherwise support a means for determining an offset between a search space associated with the wireless node and a search space associated with the UE. In some examples, the search space manager 1045 may be configured as or otherwise support a means for monitoring the search space associated with the UE for the grant of resources, where the determining is based on the monitoring the search space associated with the UE.

In some examples, the shared RNTI is a cell-specific RNTI.

In some examples, the wireless node includes a programmable logic controller of an industrial internet of things deployment. In some examples, the UE includes a sensor/actuator of the industrial internet of things deployment, where the UE is in a star topology with the wireless node.

In some examples, the wireless node includes a central sidelink UE of a set of multiple connected sidelink UEs.

In some examples, the first wireless communication link includes a cellular communications link. In some examples, the second wireless communication link includes a sidelink communications link.

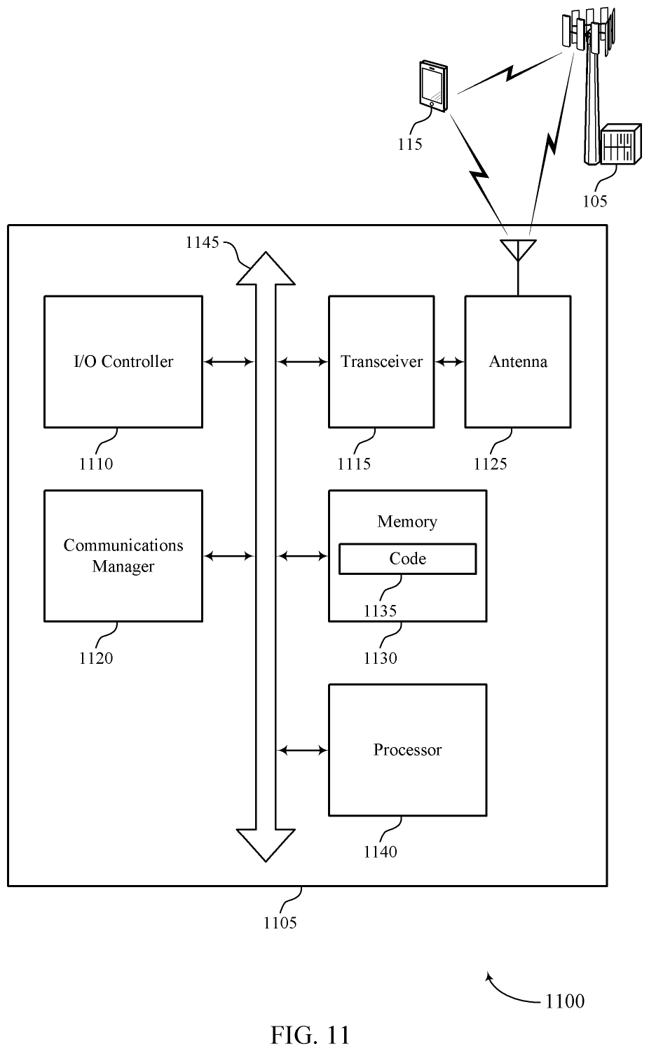

FIG. 11 shows a diagram of a system 1100 including a device 1105 that supports signaling for base station-controlled sidelink grants in accordance with aspects of the present disclosure. The device 1105 may be an example of or include the components of a device 805, a device 905, or a UE 115 as described herein. The device 1105 may communicate wirelessly with one or more base stations 105, UEs 115, or any combination thereof. The device 1105 may include components for bi-directional voice and data communications including components for transmitting and receiving communications, such as a communications manager 1120, an input/output (I/O) controller 1110, a transceiver 1115, an antenna 1125, a memory 1130, code 1135, and a processor 1140. These components may be in electronic communication or otherwise coupled (e.g., operatively, communicatively, functionally, electronically, electrically) via one or more buses (e.g., a bus 1145).

The I/O controller 1110 may manage input and output signals for the device 1105. The I/O controller 1110 may also manage peripherals not integrated into the device 1105. In some cases, the I/O controller 1110 may represent a physical connection or port to an external peripheral. In some cases, the I/O controller 1110 may utilize an operating system such as iOS®, ANDROID®, MS-DOS®, MS-WINDOWS®, OS/2®, UNIX®, LINUX®, or another known operating system. Additionally, or alternatively, the I/O controller 1110 may represent or interact with a modem, a keyboard, a mouse, a touchscreen, or a similar device. In some cases, the I/O controller 1110 may be implemented as part of a processor, such as the processor 1140. In some cases, a user may interact with the device 1105 via the I/O controller 1110 or via hardware components controlled by the I/O controller 1110.

In some cases, the device 1105 may include a single antenna 1125. However, in some other cases, the device 1105 may have more than one antenna 1125, which may be capable of concurrently transmitting or receiving multiple wireless transmissions. The transceiver 1115 may communicate bi-directionally, via the one or more antennas 1125, wired, or wireless links as described herein. For example, the transceiver 1115 may represent a wireless transceiver and may communicate bi-directionally with another wireless transceiver. The transceiver 1115 may also include a modem to modulate the packets, to provide the modulated packets to one or more antennas 1125 for transmission, and to demodulate packets received from the one or more antennas 1125. The transceiver 1115, or the transceiver 1115 and one or more antennas 1125, may be an example of a transmitter 815, a transmitter 915, a receiver 810, a receiver 910, or any combination thereof or component thereof, as described herein.

The memory 1130 may include random access memory (RAM) and read-only memory (ROM). The memory 1130 may store computer-readable, computer-executable code 1135 including instructions that, when executed by the processor 1140, cause the device 1105 to perform various functions described herein. The code 1135 may be stored in a non-transitory computer-readable medium such as system memory or another type of memory. In some cases, the code 1135 may not be directly executable by the processor 1140 but may cause a computer (e.g., when compiled and executed) to perform functions described herein. In some cases, the memory 1130 may contain, among other things, a basic I/O system (BIOS) which may control basic hardware or software operation such as the interaction with peripheral components or devices.

The processor 1140 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1140 may be configured to operate a memory array using a memory controller. In some other cases, a memory controller may be integrated into the processor 1140. The processor 1140 may be configured to execute computer-readable instructions stored in a memory (e.g., the memory 1130) to cause the device 1105 to perform various functions (e.g., functions or tasks supporting signaling for base station-controlled sidelink grants). For example, the device 1105 or a component of the device 1105 may include a processor 1140 and memory 1130 coupled with or to the processor 1140, the processor 1140 and memory 1130 configured to perform various functions described herein.

The communications manager 1120 may support wireless communications at a wireless node in accordance with examples as disclosed herein. For example, the communications manager 1120 may be configured as or otherwise support a means for communicating with a base station via a first wireless communication link and with a UE via a second wireless communication link. The communications manager 1120 may be configured as or otherwise support a means for receiving, from the base station via the first wireless communication link, a grant of resources associated with the second wireless communication link, where the grant of resources is encoded with a shared RNTI that is shared by both the wireless node and the UE. The communications manager 1120 may be configured as or otherwise support a means for determining, based on the shared RNTI, that the grant of resources is for the UE. The communications manager 1120 may be configured as or otherwise support a means for forwarding the grant to the UE.

By including or configuring the communications manager 1120 in accordance with examples as described herein, the device 1105 may support techniques sidelink communications resulting in more efficient use of available communication resources, improved reliability of communications, decreased system latency, and improved user experience.

In some examples, the communications manager 1120 may be configured to perform various operations (e.g., receiving, monitoring, transmitting) using or otherwise in cooperation with the transceiver 1115, the one or more antennas 1125, or any combination thereof. Although the communications manager 1120 is illustrated as a separate component, in some examples, one or more functions described with reference to the communications manager 1120 may be supported by or performed by the processor 1140, the memory 1130, the code 1135, or any combination thereof. For example, the code 1135 may include instructions executable by the processor 1140 to cause the device 1105 to perform various aspects of signaling for base station-controlled sidelink grants as described herein, or the processor 1140 and the memory 1130 may be otherwise configured to perform or support such operations.

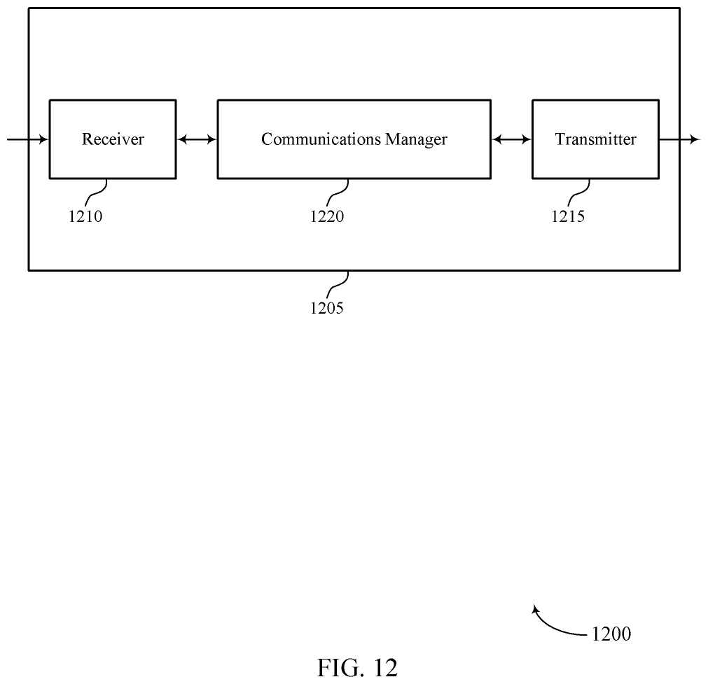

FIG. 12 shows a block diagram 1200 of a device 1205 that supports signaling for base station-controlled sidelink grants in accordance with aspects of the present disclosure. The device 1205 may be an example of aspects of a base station 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for receiving information such as packets, user data, control information, or any combination thereof associated with various information channels (e.g., control channels, data channels, information channels related to signaling for base station-controlled sidelink grants). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to signaling for base station-controlled sidelink grants). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations thereof or various components thereof may be examples of means for performing various aspects of signaling for base station-controlled sidelink grants as described herein. For example, the communications manager 1220, the receiver 1210, the transmitter 1215, or various combinations or components thereof may support a method for performing one or more of the functions described herein.

In some examples, the communications manager 1220, the receiver 1210, the transmitter 1215, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1220, the receiver 1210, the transmitter 1215, or various combinations or components thereof may be implemented in code (e.g., as communications management software or firmware) executed by a processor. If implemented in code executed by a processor, the functions of the communications manager 1220, the receiver 1210, the transmitter 1215, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1220 may be configured to perform various operations (e.g., receiving, monitoring, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to receive information, transmit information, or perform various other operations as described herein.

The communications manager 1220 may support wireless communications at a base station in accordance with examples as disclosed herein. For example, the communications manager 1220 may be configured as or otherwise support a means for communicating with a wireless node via a first wireless communication link. The communications manager 1220 may be configured as or otherwise support a means for encoding a grant of resources with a shared RNTI that is shared by both the wireless node and a UE, where the grant of resources is associated with a second wireless communication link for communication between the wireless node and the UE. The communications manager 1220 may be configured as or otherwise support a means for transmitting, to the wireless node via the first wireless communication link, the grant of resources.

By including or configuring the communications manager 1220 in accordance with examples as described herein, the device 1205 (e.g., a processor controlling or otherwise coupled to the receiver 1210, the transmitter 1215, the communications manager 1220, or a combination thereof) may support techniques for sidelink communications resulting in more efficient use of available communication resources, improved reliability of communications, decreased latency, and improved user experience.

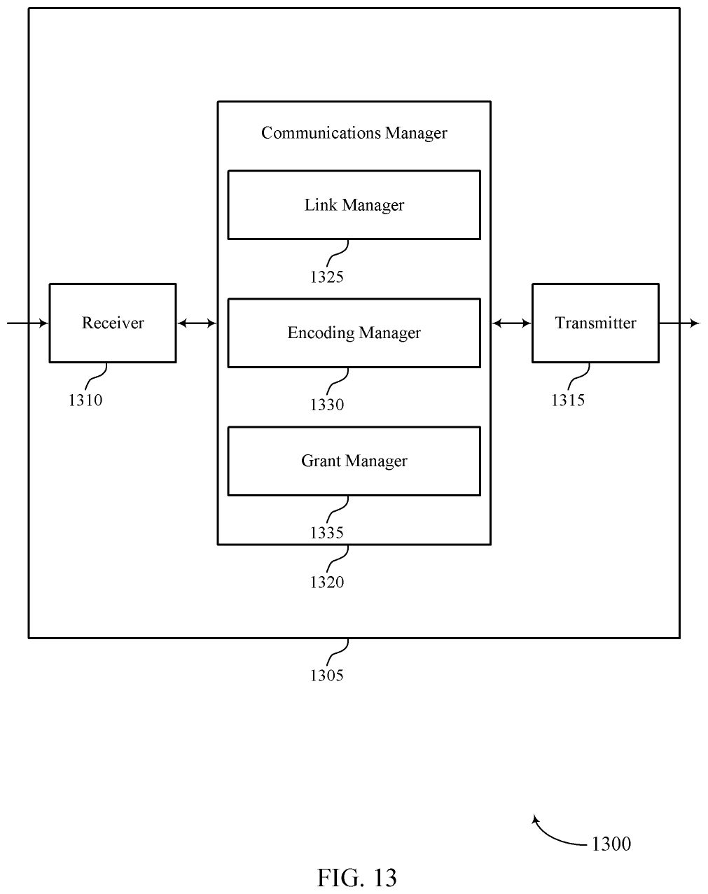

FIG. 13 shows a block diagram 1300 of a device 1305 that supports signaling for base station-controlled sidelink grants in accordance with aspects of the present disclosure. The device 1305 may be an example of aspects of a device 1205 or a base station 105 as described herein. The device 1305 may include a receiver 1310, a transmitter 1315, and a communications manager 1320. The device 1305 may also include a processor. Each of these components may be in communication with one another (e.g., via one or more buses).

The receiver 1310 may provide a means for receiving information such as packets, user data, control information, or any combination thereof associated with various information channels (e.g., control channels, data channels, information channels related to signaling for base station-controlled sidelink grants). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to signaling for base station-controlled sidelink grants). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of signaling for base station-controlled sidelink grants as described herein. For example, the communications manager 1320 may include a link manager 1325, an encoding manager 1330, a grant manager 1335, or any combination thereof. The communications manager 1320 may be an example of aspects of a communications manager 1220 as described herein. In some examples, the communications manager 1320, or various components thereof, may be configured to perform various operations (e.g., receiving, monitoring, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to receive information, transmit information, or perform various other operations as described herein.

The communications manager 1320 may support wireless communications at a base station in accordance with examples as disclosed herein. The link manager 1325 may be configured as or otherwise support a means for communicating with a wireless node via a first wireless communication link. The encoding manager 1330 may be configured as or otherwise support a means for encoding a grant of resources with a shared RNTI that is shared by both the wireless node and a UE, where the grant of resources is associated with a second wireless communication link for communication between the wireless node and the UE. The grant manager 1335 may be configured as or otherwise support a means for transmitting, to the wireless node via the first wireless communication link, the grant of resources.

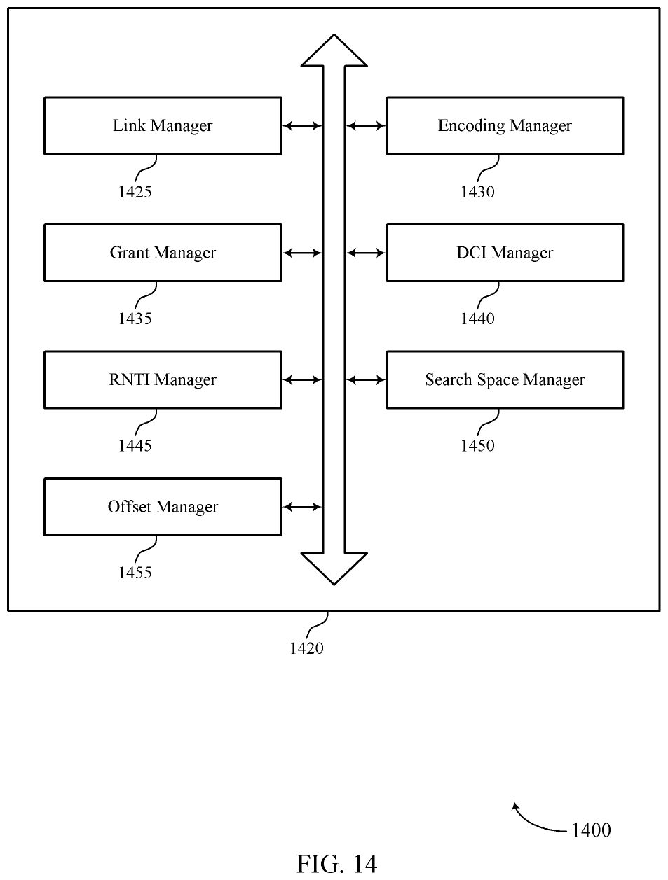

FIG. 14 shows a block diagram 1400 of a communications manager 1420 that supports signaling for base station-controlled sidelink grants in accordance with aspects of the present disclosure. The communications manager 1420 may be an example of aspects of a communications manager 1220, a communications manager 1320, or both, as described herein. The communications manager 1420, or various components thereof, may be an example of means for performing various aspects of signaling for base station-controlled sidelink grants as described herein. For example, the communications manager 1420 may include a link manager 1425, an encoding manager 1430, a grant manager 1435, a DCI manager 1440, an RNTI manager 1445, a search space manager 1450, an offset manager 1455, or any combination thereof. Each of these components may communicate, directly or indirectly, with one another (e.g., via one or more buses).

The communications manager 1420 may support wireless communications at a base station in accordance with examples as disclosed herein. The link manager 1425 may be configured as or otherwise support a means for communicating with a wireless node via a first wireless communication link. The encoding manager 1430 may be configured as or otherwise support a means for encoding a grant of resources with a shared RNTI that is shared by both the wireless node and a UE, where the grant of resources is associated with a second wireless communication link for communication between the wireless node and the UE. The grant manager 1435 may be configured as or otherwise support a means for transmitting, to the wireless node via the first wireless communication link, the grant of resources.

In some examples, to support transmitting the grant of resources, the DCI manager 1440 may be configured as or otherwise support a means for transmitting a DCI message that includes the grant of resources in a search space of a control resource set associated with the wireless node on the first wireless communication link, where the DCI message is encoded with the shared RNTI which is an identifier of the wireless node.

In some examples, including, in a field of the DCI message including the grant of resources, a destination identifier associated with the UE.

In some examples, the encoding manager 1430 may be configured as or otherwise support a means for encoding a cyclic redundancy check associated with the grant of resources using the RNTI which is the identifier of the wireless node and a destination identifier associated with the UE, where the transmitting is based on encoding the cyclic redundancy check.

In some examples, the grant manager 1435 may be configured as or otherwise support a means for determining that a second grant of resources associated with the second wireless communication link is for the wireless node. In some examples, the grant manager 1435 may be configured as or otherwise support a means for transmitting, to the wireless node via the first wireless communication link based on the determining, the second grant of resources, where the second grant of resources is encoded with a second shared RNTI that is shared by both the wireless node and the UE, and where the second grant of resources includes an indication of an identifier associated with the wireless node.

In some examples, the grant manager 1435 may be configured as or otherwise support a means for determining that a second grant of resources associated with the second wireless communication link is for the wireless node. In some examples, the encoding manager 1430 may be configured as or otherwise support a means for refraining from encoding a cyclic redundancy check associated with the second grant of resources using an identifier associated with the UE. In some examples, the grant manager 1435 may be configured as or otherwise support a means for transmitting, to the wireless node via the first wireless communication link based on the determining, the second grant of resources, where the second grant of resources is encoded with a second shared RNTI that is shared by both the wireless node and the UE.

In some examples, the RNTI manager 1445 may be configured as or otherwise support a means for transmitting, to the wireless node, an indication of a set of RNTIs associated with respective UEs of a set of UEs including the UE, where the set of RNTIs includes the shared RNTI. In some examples, the search space manager 1450 may be configured as or otherwise support a means for determining that the grant of resources is for the UE, where transmitting the grant of resources includes transmitting a DCI message that includes the grant of resources on a search space of a control resource set associated with the wireless node on the first wireless communication link, where the DCI message is encoded with the shared RNTI which is an identifier of the UE.

In some examples, the DCI manager 1440 may be configured as or otherwise support a means for including, in a field of the DCI message including the grant of resources, a one-bit indication that the grant of resources is for the UE.

In some examples, to support encoding the grant of resources, the encoding manager 1430 may be configured as or otherwise support a means for encoding a cyclic redundancy check associated with the grant of resources using the shared RNTI which is the identifier of the UE and a destination identifier associated with the UE.

In some examples, the search space manager 1450 may be configured as or otherwise support a means for transmitting, to the wireless node, the UE, or both, an indication of a search space associated with the UE, where transmitting the grant of resources includes transmitting the grant of resources on the search space associated with the UE.

In some examples, the offset manager 1455 may be configured as or otherwise support a means for determining an offset between a search space associated with the wireless node and a search space associated with the UE, where transmitting the grant of resources includes transmitting the grant of resources via the search space associated with the UE.

In some examples, the wireless node includes a programmable logic controller of an industrial internet of things deployment. In some examples, the UE includes a sensor/actuator of the industrial internet of things deployment, where the UE is in a star topology with the wireless node.

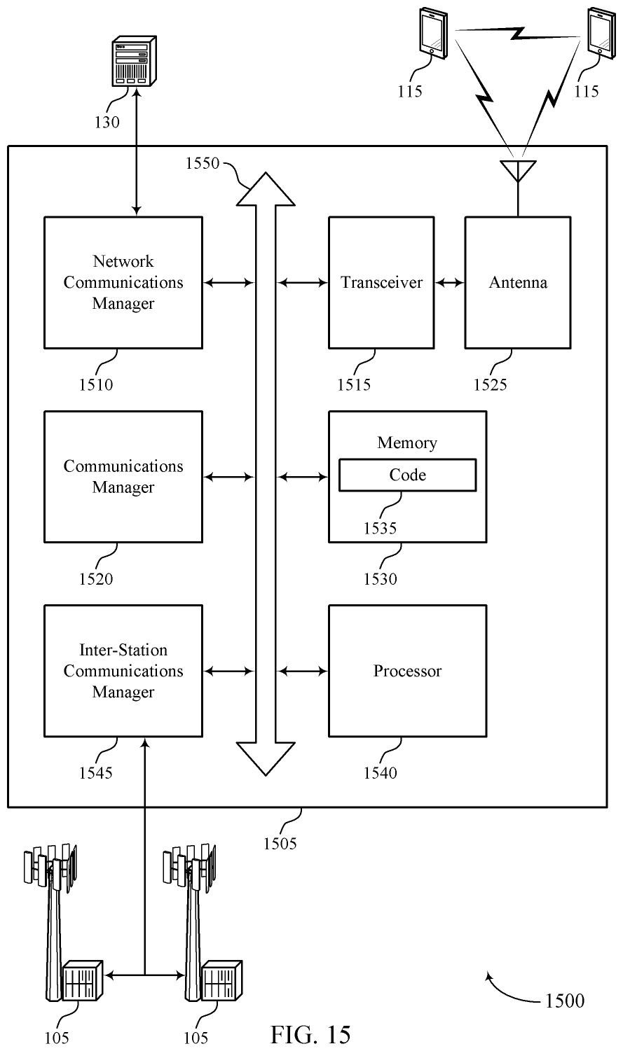

FIG. 15 shows a diagram of a system 1500 including a device 1505 that supports signaling for base station-controlled sidelink grants in accordance with aspects of the present disclosure. The device 1505 may be an example of or include the components of a device 1205, a device 1305, or a base station 105 as described herein. The device 1505 may communicate wirelessly with one or more base stations 105, UEs 115, or any combination thereof. The device 1505 may include components for bi-directional voice and data communications including components for transmitting and receiving communications, such as a communications manager 1520, a network communications manager 1510, a transceiver 1515, an antenna 1525, a memory 1530, code 1535, a processor 1540, and an inter-station communications manager 1545. These components may be in electronic communication or otherwise coupled (e.g., operatively, communicatively, functionally, electronically, electrically) via one or more buses (e.g., a bus 1550).

The network communications manager 1510 may manage communications with a core network 130 (e.g., via one or more wired backhaul links). For example, the network communications manager 1510 may manage the transfer of data communications for client devices, such as one or more UEs 115.

In some cases, the device 1505 may include a single antenna 1525. However, in some other cases the device 1505 may have more than one antenna 1525, which may be capable of concurrently transmitting or receiving multiple wireless transmissions. The transceiver 1515 may communicate bi-directionally, via the one or more antennas 1525, wired, or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The memory 1530 may include RAM and ROM. The memory 1530 may store computer-readable, computer-executable code 1535 including instructions that, when executed by the processor 1540, cause the device 1505 to perform various functions described herein. The code 1535 may be stored in a non-transitory computer-readable medium such as system memory or another type of memory. In some cases, the code 1535 may not be directly executable by the processor 1540 but may cause a computer (e.g., when compiled and executed) to perform functions described herein. In some cases, the memory 1530 may contain, among other things, a BIOS which may control basic hardware or software operation such as the interaction with peripheral components or devices.

The processor 1540 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1540 may be configured to operate a memory array using a memory controller. In some other cases, a memory controller may be integrated into the processor 1540. The processor 1540 may be configured to execute computer-readable instructions stored in a memory (e.g., the memory 1530) to cause the device 1505 to perform various functions (e.g., functions or tasks supporting signaling for base station-controlled sidelink grants). For example, the device 1505 or a component of the device 1505 may include a processor 1540 and memory 1530 coupled with or to the processor 1540, the processor 1540 and memory 1530 configured to perform various functions described herein.

The inter-station communications manager 1545 may manage communications with other base stations 105, and may include a controller or scheduler for controlling communications with UEs 115 in cooperation with other base stations 105. For example, the inter-station communications manager 1545 may coordinate scheduling for transmissions to UEs 115 for various interference mitigation techniques such as beamforming or joint transmission. In some examples, the inter-station communications manager 1545 may provide an X2 interface within an LTE/LTE-A wireless communications network technology to provide communication between base stations 105.

The communications manager 1520 may support wireless communications at a base station in accordance with examples as disclosed herein. For example, the communications manager 1520 may be configured as or otherwise support a means for communicating with a wireless node via a first wireless communication link. The communications manager 1520 may be configured as or otherwise support a means for encoding a grant of resources with a shared RNTI that is shared by both the wireless node and a UE, where the grant of resources is associated with a second wireless communication link for communication between the wireless node and the UE. The communications manager 1520 may be configured as or otherwise support a means for transmitting, to the wireless node via the first wireless communication link, the grant of resources.

By including or configuring the communications manager 1520 in accordance with examples as described herein, the device 1505 may support techniques for sidelink communications resulting in more efficient use of available communication resources, improved reliability of communications, decreased latency, and improved user experience.

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the processor 1540, the memory 1530, the code 1535, or any combination thereof. For example, the code 1535 may include instructions executable by the processor 1540 to cause the device 1505 to perform various aspects of signaling for base station-controlled sidelink grants as described herein, or the processor 1540 and the memory 1530 may be otherwise configured to perform or support such operations.

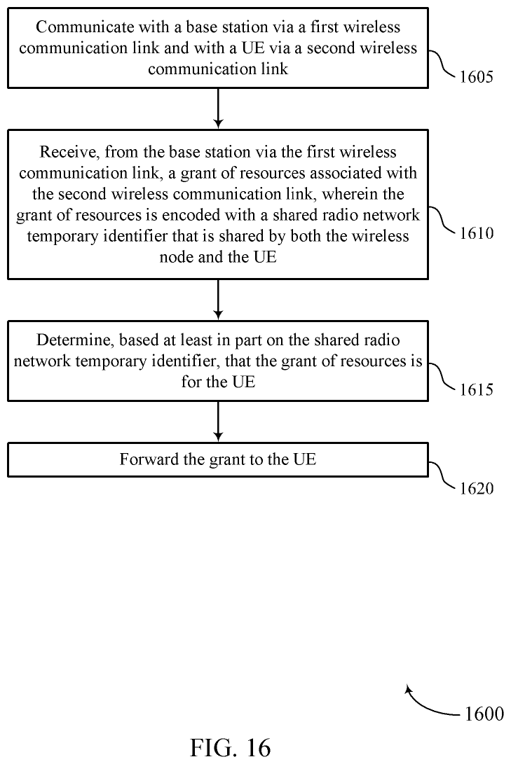

FIG. 16 shows a flowchart illustrating a method 1600 that supports signaling for base station-controlled sidelink grants in accordance with aspects of the present disclosure. The operations of the method 1600 may be implemented by a UE or its components as described herein. For example, the operations of the method 1600 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1605, the method may include communicating with a base station via a first wireless communication link and with a UE via a second wireless communication link. The operations of 1605 may be performed in accordance with examples as disclosed herein. In some examples, aspects of the operations of 1605 may be performed by a link manager 1025 as described with reference to FIG. 10.

At 1610, the method may include receiving, from the base station via the first wireless communication link, a grant of resources associated with the second wireless communication link, where the grant of resources is encoded with a shared RNTI that is shared by both the wireless node and the UE. The operations of 1610 may be performed in accordance with examples as disclosed herein. In some examples, aspects of the operations of 1610 may be performed by a grant manager 1030 as described with reference to FIG. 10.

At 1615, the method may include determining, based on the shared RNTI, that the grant of resources is for the UE. The operations of 1615 may be performed in accordance with examples as disclosed herein. In some examples, aspects of the operations of 1615 may be performed by a shared RNTI manager 1035 as described with reference to FIG. 10.

At 1620, the method may include forwarding the grant to the UE. The operations of 1620 may be performed in accordance with examples as disclosed herein. In some examples, aspects of the operations of 1620 may be performed by a grant manager 1030 as described with reference to FIG. 10.

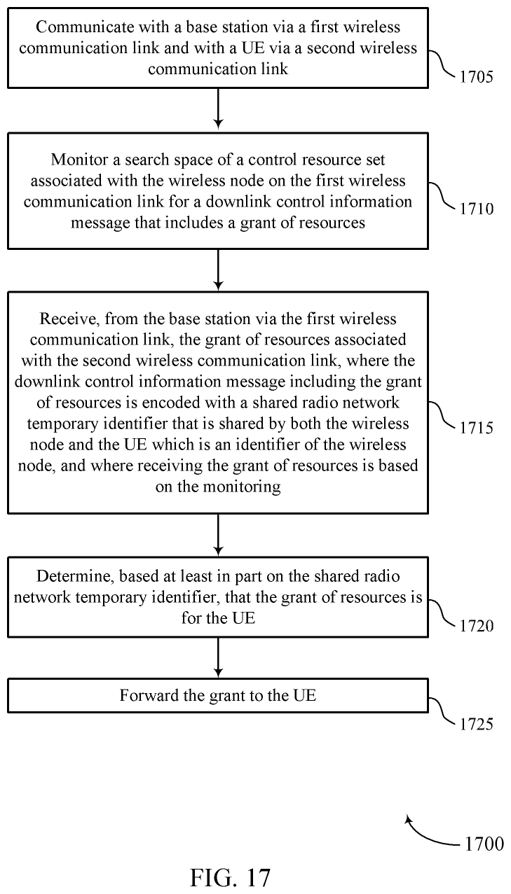

FIG. 17 shows a flowchart illustrating a method 1700 that supports signaling for base station-controlled sidelink grants in accordance with aspects of the present disclosure. The operations of the method 1700 may be implemented by a UE or its components as described herein. For example, the operations of the method 1700 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1705, the method may include communicating with a base station via a first wireless communication link and with a UE via a second wireless communication link. The operations of 1705 may be performed in accordance with examples as disclosed herein. In some examples, aspects of the operations of 1705 may be performed by a link manager 1025 as described with reference to FIG. 10.

At 1710, the method may include monitoring a search space of a control resource set associated with the wireless node on the first wireless communication link for a DCI message that includes a grant of resources. The operations of 1710 may be performed in accordance with examples as disclosed herein. In some examples, aspects of the operations of 1710 may be performed by a monitoring manager 1040 as described with reference to FIG. 10.

At 1715, the method may include receiving, from the base station via the first wireless communication link, the grant of resources associated with the second wireless communication link, where the DCI message including the grant of resources is encoded with a shared RNTI that is shared by both the wireless node and the UE which is an identifier of the wireless node, and where receiving the grant of resources is based on the monitoring. The operations of 1715 may be performed in accordance with examples as disclosed herein. In some examples, aspects of the operations of 1715 may be performed by a grant manager 1030 as described with reference to FIG. 10.

At 1720, the method may include determining, based on the shared RNTI, that the grant of resources is for the UE. The operations of 1720 may be performed in accordance with examples as disclosed herein. In some examples, aspects of the operations of 1720 may be performed by a shared RNTI manager 1035 as described with reference to FIG. 10.

At 1725, the method may include forwarding the grant to the UE. The operations of 1725 may be performed in accordance with examples as disclosed herein. In some examples, aspects of the operations of 1725 may be performed by a grant manager 1030 as described with reference to FIG. 10.

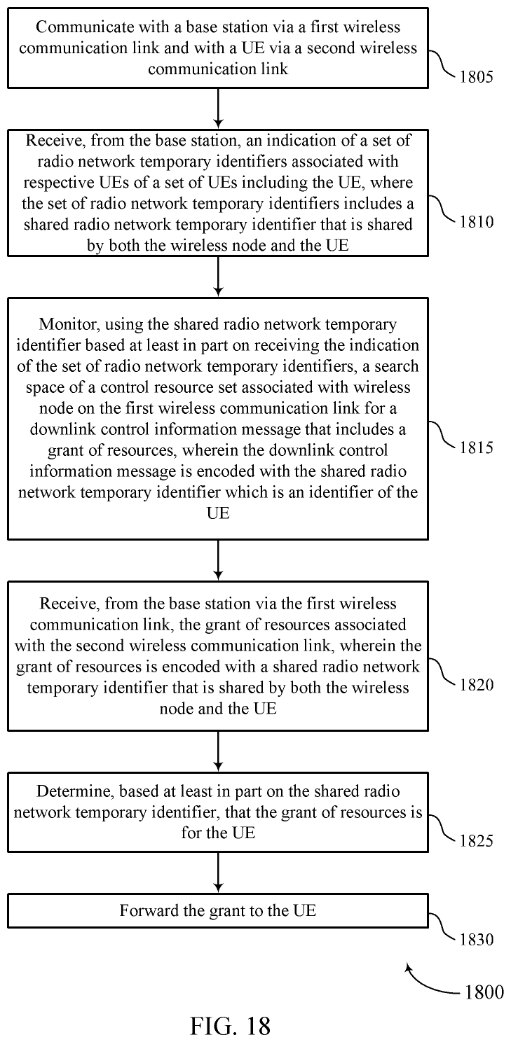

FIG. 18 shows a flowchart illustrating a method 1800 that supports signaling for base station-controlled sidelink grants in accordance with aspects of the present disclosure. The operations of the method 1800 may be implemented by a UE or its components as described herein. For example, the operations of the method 1800 may be performed by a UE 115 as described with reference to FIGS. 1 through 11. In some examples, a UE may execute a set of instructions to control the functional elements of the UE to perform the described functions. Additionally, or alternatively, the UE may perform aspects of the described functions using special-purpose hardware.

At 1805, the method may include communicating with a base station via a first wireless communication link and with a UE via a second wireless communication link. The operations of 1805 may be performed in accordance with examples as disclosed herein. In some examples, aspects of the operations of 1805 may be performed by a link manager 1025 as described with reference to FIG. 10.

At 1810, the method may include receiving, from the base station, an indication of a set of RNTIs associated with respective UEs of a set of UEs including the UE, where the set of RNTIs includes a shared RNTI that is shared by both the wireless node and the UE. The operations of 1810 may be performed in accordance with examples as disclosed herein. In some examples, aspects of the operations of 1810 may be performed by a shared RNTI manager 1035 as described with reference to FIG. 10.

At 1815, the method may include monitoring, using the shared RNTI based on receiving the indication of the set of RNTIs, a search space of a control resource set associated with the wireless node on the first wireless communication link for a DCI message that includes a grant of resources, where the DCI message is encoded with the shared RNTI which is an identifier of the UE. The operations of 1815 may be performed in accordance with examples as disclosed herein. In some examples, aspects of the operations of 1815 may be performed by a monitoring manager 1040 as described with reference to FIG. 10.

At 1820, the method may include receiving, from the base station via the first wireless communication link, the grant of resources associated with the second wireless communication link, where the grant of resources is encoded with a shared RNTI that is shared by both the wireless node and the UE. The operations of 1820 may be performed in accordance with examples as disclosed herein. In some examples, aspects of the operations of 1820 may be performed by a grant manager 1030 as described with reference to FIG. 10.

At 1825, the method may include determining, based on the shared RNTI, that the grant of resources is for the UE. The operations of 1825 may be performed in accordance with examples as disclosed herein. In some examples, aspects of the operations of 1825 may be performed by a shared RNTI manager 1035 as described with reference to FIG. 10.

At 1830, the method may include forwarding the grant to the UE. The operations of 1830 may be performed in accordance with examples as disclosed herein. In some examples, aspects of the operations of 1830 may be performed by a grant manager 1030 as described with reference to FIG. 10.

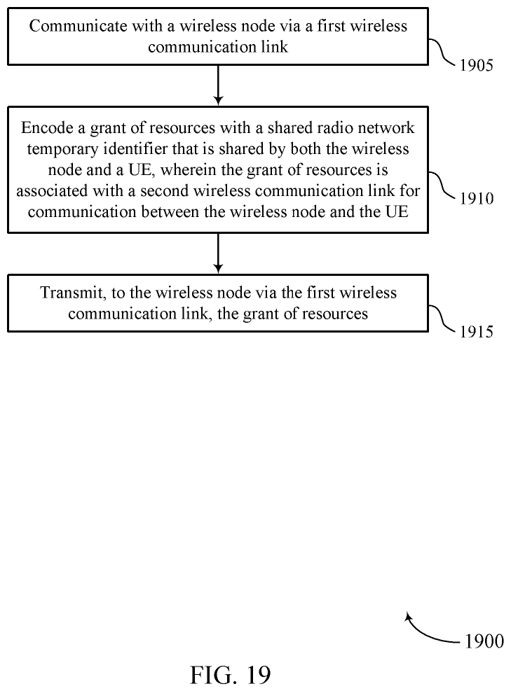

FIG. 19 shows a flowchart illustrating a method 1900 that supports signaling for base station-controlled sidelink grants in accordance with aspects of the present disclosure. The operations of the method 1900 may be implemented by a base station or its components as described herein. For example, the operations of the method 1900 may be performed by a base station 105 as described with reference to FIGS. 1 through 7 and 12 through 15. In some examples, a base station may execute a set of instructions to control the functional elements of the base station to perform the described functions. Additionally, or alternatively, the base station may perform aspects of the described functions using special-purpose hardware.

At 1905, the method may include communicating with a wireless node via a first wireless communication link. The operations of 1905 may be performed in accordance with examples as disclosed herein. In some examples, aspects of the operations of 1905 may be performed by a link manager 1425 as described with reference to FIG. 14.

At 1910, the method may include encoding a grant of resources with a shared RNTI that is shared by both the wireless node and a UE, where the grant of resources is associated with a second wireless communication link for communication between the wireless node and the UE. The operations of 1910 may be performed in accordance with examples as disclosed herein. In some examples, aspects of the operations of 1910 may be performed by an encoding manager 1430 as described with reference to FIG. 14.

At 1915, the method may include transmitting, to the wireless node via the first wireless communication link, the grant of resources. The operations of 1915 may be performed in accordance with examples as disclosed herein. In some examples, aspects of the operations of 1915 may be performed by a grant manager 1435 as described with reference to FIG. 14.

The following provides an overview of aspects of the present disclosure:

Aspect 1: A method for wireless communications at a wireless node, comprising: communicating with a base station via a first wireless communication link and with a UE via a second wireless communication link; receiving, from the base station via the first wireless communication link, a grant of resources associated with the second wireless communication link, wherein the grant of resources is encoded with a shared RNTI that is shared by both the wireless node and the UE; determining, based at least in part on the shared RNTI, that the grant of resources is for the UE; and forwarding the grant to the UE.

Aspect 2: The method of aspect 1, further comprising: monitoring a search space of a control resource set associated with the wireless node on the first wireless communication link for a DCI message that includes the grant of resources, wherein the DCI message is encoded with the shared RNTI which is an identifier of the wireless node, and wherein receiving the grant of resources is based at least in part on the monitoring.

Aspect 3: The method of aspect 2, further comprising: receiving, in a field of the DCI message comprising the grant of resources, a destination identifier associated with the UE, wherein the determining is based at least in part on receiving the destination identifier.

Aspect 4: The method of any of aspects 2 through 3, further comprising: decoding a cyclic redundancy check associated with the grant of resources; and identifying, based at least in part on the decoding, the shared RNTI which is the identifier of the wireless node and a destination identifier associated with the UE, wherein the determining is based at least in part on identifying the destination identifier.

Aspect 5: The method of any of aspects 2 through 4, further comprising: receiving, from the base station via the first wireless communication link, a second grant of resources associated with the second wireless communication link, wherein the second grant of resources is encoded with a second shared RNTI that is shared by both the wireless node and the UE; identifying, in the second grant of resources, an identifier associated with the wireless node; determining, based at least in part on the second shared RNTI and the identifier associated with the wireless node, that the second grant of resources is for the wireless node; and performing sidelink communications on the second wireless communication link according to the second grant of resources.

Aspect 6: The method of any of aspects 2 through 5, further comprising: receiving, from the base station via the first wireless communication link, a second grant of resources associated with the second wireless communication link, wherein the second grant of resources is encoded with a second shared RNTI that is shared by both the wireless node and the UE; decoding a cyclic redundancy check associated with the second grant of resources; determining, based at least in part on the second shared RNTI and an absence of an identifier associated with the UE, that the second grant of resources is for the wireless node; and performing sidelink communications on the second wireless communication link according to the second grant of resources.

Aspect 7: The method of any of aspects 1 through 6, further comprising: receiving, from the base station, an indication of a set of RNTIs associated with respective UEs of a set of UEs comprising the UE, wherein the set of RNTIs comprises the shared RNTI; and monitoring, using the shared RNTI based at least in part on receiving the indication of the set of RNTIs, a search space of a control resource set associated with wireless node on the first wireless communication link for a DCI message that includes the grant of resources, wherein the DCI message is encoded with the shared RNTI which is an identifier of the UE.

Aspect 8: The method of aspect 7, further comprising: receiving, in a field of the DCI message comprising the grant of resources, a one-bit indication that the grant of resources is for the UE, wherein the determining is based at least in part on receiving the one-bit indication.

Aspect 9: The method of any of aspects 7 through 8, further comprising: decoding a cyclic redundancy check associated with the grant of resources; and identifying, based at least in part on the decoding, the shared RNTI which is the identifier of the UE and a destination identifier associated with the UE, wherein the determining is based at least in part on identifying the destination identifier.

Aspect 10: The method of any of aspects 7 through 9, wherein the set of UEs comprises respective UEs that are operating in a connected mode with the UE.

Aspect 11: The method of any of aspects 1 through 10, further comprising: receiving, from the base station, an indication of a search space associated with the UE; and monitoring the search space for the grant of resources, wherein the determining is based at least in part on the monitoring the search space.

Aspect 12: The method of any of aspects 1 through 11, further comprising: determining an offset between a search space associated with the wireless node and a search space associated with the UE; and monitoring the search space associated with the UE for the grant of resources, wherein the determining is based at least in part on the monitoring the search space associated with the UE.

Aspect 13: The method of any of aspects 1 through 12, wherein the shared RNTI is a cell-specific RNTI.

Aspect 14: The method of any of aspects 1 through 13, wherein the wireless node comprises a programmable logic controller of an industrial internet of things deployment; and the UE comprises a sensor/actuator of the industrial internet of things deployment, wherein the UE is in a star topology with the wireless node.

Aspect 15: The method of any of aspects 1 through 14, wherein the wireless node comprises a central sidelink UE of a plurality of connected sidelink UEs.

Aspect 16: The method of any of aspects 1 through 15, wherein the first wireless communication link comprises a cellular communications link; and the second wireless communication link comprises a sidelink communications link.

Aspect 17: A method for wireless communications at a base station, comprising: communicating with a wireless node via a first wireless communication link; encoding a grant of resources with a shared RNTI that is shared by both the wireless node and a UE, wherein the grant of resources is associated with a second wireless communication link for communication between the wireless node and the UE; transmitting, to the wireless node via the first wireless communication link, the grant of resources.

Aspect 18: The method of aspect 17, wherein transmitting the grant of resources comprises: transmitting a DCI message that includes the grant of resources in a search space of a control resource set associated with the wireless node on the first wireless communication link, wherein the DCI message is encoded with the shared RNTI which is an identifier of the wireless node.

Aspect 19: The method of aspect 18, wherein including, in a field of the DCI message comprising the grant of resources, a destination identifier associated with the UE.

Aspect 20: The method of any of aspects 18 through 19, further comprising: encoding a cyclic redundancy check associated with the grant of resources using the RNTI which is the identifier of the wireless node and a destination identifier associated with the UE, wherein the transmitting is based at least in part on encoding the cyclic redundancy check.

Aspect 21: The method of any of aspects 18 through 20, further comprising: determining that a second grant of resources associated with the second wireless communication link is for the wireless node; and transmitting, to the wireless node via the first wireless communication link based at least in part on the determining, the second grant of resources, wherein the second grant of resources is encoded with a second shared RNTI that is shared by both the wireless node and the UE, and wherein the second grant of resources includes an indication of an identifier associated with the wireless node.

Aspect 22: The method of any of aspects 18 through 21, further comprising: determining that a second grant of resources associated with the second wireless communication link is for the wireless node; refraining from encoding a cyclic redundancy check associated with the second grant of resources using an identifier associated with the UE; and transmitting, to the wireless node via the first wireless communication link based at least in part on the determining, the second grant of resources, wherein the second grant of resources is encoded with a second shared RNTI that is shared by both the wireless node and the UE.

Aspect 23: The method of any of aspects 17 through 22, further comprising: transmitting, to the wireless node, an indication of a set of RNTIs associated with respective UEs of a set of UEs comprising the UE, wherein the set of RNTIs comprises the shared RNTI; and determining that the grant of resources is for the UE, wherein transmitting the grant of resources comprises transmitting a DCI message that includes the grant of resources on a search space of a control resource set associated with the wireless node on the first wireless communication link, wherein the DCI message is encoded with the shared RNTI which is an identifier of the UE.

Aspect 24: The method of aspect 23, further comprising: including, in a field of the DCI message comprising the grant of resources, a one-bit indication that the grant of resources is for the UE.

Aspect 25: The method of any of aspects 23 through 24, wherein encoding the grant of resources comprises: encoding a cyclic redundancy check associated with the grant of resources using the shared RNTI which is the identifier of the UE and a destination identifier associated with the UE.

Aspect 26: The method of any of aspects 17 through 25, further comprising: transmitting, to the wireless node, the UE, or both, an indication of a search space associated with the UE, wherein transmitting the grant of resources comprises transmitting the grant of resources on the search space associated with the UE.

Aspect 27: The method of any of aspects 17 through 26, further comprising: determining an offset between a search space associated with the wireless node and a search space associated with the UE, wherein transmitting the grant of resources comprises transmitting the grant of resources via the search space associated with the UE.

Aspect 28: The method of any of aspects 17 through 27, wherein the wireless node comprises a programmable logic controller of an industrial internet of things deployment; and the UE comprises a sensor/actuator of the industrial internet of things deployment, wherein the UE is in a star topology with the wireless node.

Aspect 29: An apparatus for wireless communications at a wireless node, comprising a processor; memory coupled with the processor; and instructions stored in the memory and executable by the processor to cause the apparatus to perform a method of any of aspects 1 through 16.

Aspect 30: An apparatus for wireless communications at a wireless node, comprising at least one means for performing a method of any of aspects 1 through 16.

Aspect 31: A non-transitory computer-readable medium storing code for wireless communications at a wireless node, the code comprising instructions executable by a processor to perform a method of any of aspects 1 through 16.

Aspect 32: An apparatus for wireless communications at a base station, comprising a processor; memory coupled with the processor; and instructions stored in the memory and executable by the processor to cause the apparatus to perform a method of any of aspects 17 through 28.

Aspect 33: An apparatus for wireless communications at a base station, comprising at least one means for performing a method of any of aspects 17 through 28.

Aspect 34: A non-transitory computer-readable medium storing code for wireless communications at a base station, the code comprising instructions executable by a processor to perform a method of any of aspects 17 through 28.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a wireless node, comprising:
communicating with a base station via a first wireless communication link and with a user equipment (UE) via a second wireless communication link;
receiving, from the base station via the first wireless communication link, a grant of resources associated with the second wireless communication link, wherein the grant of resources is encoded with a shared radio network temporary identifier that is shared by both the wireless node and the UE;
determining, based at least in part on the shared radio network temporary identifier, that the grant of resources is for the UE; and
forwarding the grant to the UE.

2. The method of claim 1, further comprising:
monitoring a search space of a control resource set associated with the wireless node on the first wireless communication link for a downlink control information message that includes the grant of resources, wherein the downlink control information message is encoded with the shared radio network temporary identifier which is an identifier of the wireless node, and wherein receiving the grant of resources is based at least in part on the monitoring.

3. The method of claim 2, further comprising:
receiving, in a field of the downlink control information message comprising the grant of resources, a destination identifier associated with the UE, wherein the determining is based at least in part on receiving the destination identifier.

4. The method of claim 2, further comprising:
decoding a cyclic redundancy check associated with the grant of resources; and
identifying, based at least in part on the decoding, the shared radio network temporary identifier which is the identifier of the wireless node and a destination identifier associated with the UE, wherein the determining is based at least in part on identifying the destination identifier.

5. The method of claim 2, further comprising:
receiving, from the base station via the first wireless communication link, a second grant of resources associated with the second wireless communication link, wherein the second grant of resources is encoded with a second shared radio network temporary identifier that is shared by both the wireless node and the UE;
identifying, in the second grant of resources, an identifier associated with the wireless node;
determining, based at least in part on the second shared radio network temporary identifier and the identifier associated with the wireless node, that the second grant of resources is for the wireless node; and
performing sidelink communications on the second wireless communication link according to the second grant of resources.

6. The method of claim 2, further comprising:
receiving, from the base station via the first wireless communication link, a second grant of resources associated with the second wireless communication link, wherein the second grant of resources is encoded with a second shared radio network temporary identifier that is shared by both the wireless node and the UE;
decoding a cyclic redundancy check associated with the second grant of resources;
determining, based at least in part on the second shared radio network temporary identifier and an absence of an identifier associated with the UE, that the second grant of resources is for the wireless node; and
performing sidelink communications on the second wireless communication link according to the second grant of resources.

7. The method of claim 1, further comprising:
receiving, from the base station, an indication of a set of radio network temporary identifiers associated with respective UEs of a set of UEs comprising the UE, wherein the set of radio network temporary identifiers comprises the shared radio network temporary identifier; and
monitoring, using the shared radio network temporary identifier based at least in part on receiving the indication of the set of radio network temporary identifiers, a search space of a control resource set associated with the wireless node on the first wireless communication link for a downlink control information message that includes the grant of resources, wherein the downlink control information message is encoded with the shared radio network temporary identifier which is an identifier of the UE.

8. The method of claim 7, further comprising:
receiving, in a field of the downlink control information message comprising the grant of resources, a one-bit indication that the grant of resources is for the UE, wherein the determining is based at least in part on receiving the one-bit indication.

9. The method of claim 7, further comprising:
decoding a cyclic redundancy check associated with the grant of resources; and
identifying, based at least in part on the decoding, the shared radio network temporary identifier which is the identifier of the UE and a destination identifier associated with the UE, wherein the determining is based at least in part on identifying the destination identifier.

10. The method of claim 7, wherein the set of UEs comprises respective UEs that are operating in a connected mode with the UE.

11. The method of claim 1, further comprising:
receiving, from the base station, an indication of a search space associated with the UE; and
monitoring the search space for the grant of resources, wherein the determining is based at least in part on the monitoring the search space.

12. The method of claim 1, further comprising:
determining an offset between a search space associated with the wireless node and a search space associated with the UE; and
monitoring the search space associated with the UE for the grant of resources, wherein the determining is based at least in part on the monitoring the search space associated with the UE.

13. The method of claim 1, wherein the shared radio network temporary identifier is a cell-specific radio network temporary identifier.

14. The method of claim 1, wherein the wireless node comprises a central sidelink UE of a plurality of connected sidelink UEs.

15. The method of claim 1, wherein:
the first wireless communication link comprises a cellular communications link; and
the second wireless communication link comprises a sidelink communications link.

16. A method for wireless communications at a base station, comprising:
communicating with a wireless node via a first wireless communication link;
encoding a grant of resources with a shared radio network temporary identifier that is shared by both the wireless node and a user equipment (UE), wherein the grant of resources is associated with a second wireless communication link for communication between the wireless node and the UE;
transmitting, to the wireless node via the first wireless communication link, the grant of resources.

17. The method of claim 16, wherein transmitting the grant of resources comprises:
transmitting a downlink control information message that includes the grant of resources in a search space of a control resource set associated with the wireless node on the first wireless communication link, wherein the downlink control information message is encoded with the shared radio network temporary identifier which is an identifier of the wireless node.

18. The method of claim 17, wherein including, in a field of the downlink control information message comprising the grant of resources, a destination identifier associated with the UE.

19. The method of claim 17, further comprising:
encoding a cyclic redundancy check associated with the grant of resources using the shared radio network temporary identifier which is the identifier of the wireless node and a destination identifier associated with the UE, wherein the transmitting is based at least in part on encoding the cyclic redundancy check.

20. The method of claim 17, further comprising:
determining that a second grant of resources associated with the second wireless communication link is for the wireless node; and
transmitting, to the wireless node via the first wireless communication link based at least in part on the determining, the second grant of resources, wherein the second grant of resources is encoded with a second shared radio network temporary identifier that is shared by both the wireless node and the UE, and wherein the second grant of resources includes an indication of an identifier associated with the wireless node.

21. The method of claim 17, further comprising:
determining that a second grant of resources associated with the second wireless communication link is for the wireless node;
refraining from encoding a cyclic redundancy check associated with the second grant of resources using an identifier associated with the UE; and
transmitting, to the wireless node via the first wireless communication link based at least in part on the determining, the second grant of resources, wherein the second grant of resources is encoded with a second shared radio network temporary identifier that is shared by both the wireless node and the UE.

22. The method of claim 16, further comprising:
transmitting, to the wireless node, an indication of a set of radio network temporary identifiers associated with respective UEs of a set of UEs comprising the UE, wherein the set of radio network temporary identifiers comprises the shared radio network temporary identifier; and
determining that the grant of resources is for the UE, wherein transmitting the grant of resources comprises transmitting a downlink control information message that includes the grant of resources on a search space of a control resource set associated with the wireless node on the first wireless communication link, wherein the downlink control information message is encoded with the shared radio network temporary identifier which is an identifier of the UE.

23. The method of claim 22, further comprising:
including, in a field of the downlink control information message comprising the grant of resources, a one-bit indication that the grant of resources is for the UE.

24. The method of claim 22, wherein encoding the grant of resources comprises:
encoding a cyclic redundancy check associated with the grant of resources using the shared radio network temporary identifier which is the identifier of the UE and a destination identifier associated with the UE.

25. The method of claim 16, further comprising:
transmitting, to the wireless node, the UE, or both, an indication of a search space associated with the UE, wherein transmitting the grant of resources comprises transmitting the grant of resources on the search space associated with the UE.

26. The method of claim 16, further comprising:
determining an offset between a search space associated with the wireless node and a search space associated with the UE, wherein transmitting the grant of resources comprises transmitting the grant of resources via the search space associated with the UE.

27. An apparatus for wireless communications at a wireless node, comprising:
a processor;
memory coupled with the processor; and
instructions stored in the memory and executable by the processor to cause the apparatus to:
communicate with a base station via a first wireless communication link and with a user equipment (UE) via a second wireless communication link;
receive, from the base station via the first wireless communication link, a grant of resources associated with the second wireless communication link, wherein the grant of resources is encoded with a shared radio network temporary identifier that is shared by both the wireless node and the UE;
determine, based at least in part on the shared radio network temporary identifier, that the grant of resources is for the UE; and
forward the grant to the UE.

28. The apparatus of claim 27, wherein the instructions are further executable by the processor to cause the apparatus to:
monitor a search space of a control resource set associated with the wireless node on the first wireless communication link for a downlink control information message that includes the grant of resources, wherein the downlink control information message is encoded with the shared radio network temporary identifier which is an identifier of the wireless node, and wherein receiving the grant of resources is based at least in part on the monitoring.

29. An apparatus for wireless communications at a base station, comprising:
a processor;
memory coupled with the processor; and
instructions stored in the memory and executable by the processor to cause the apparatus to:
communicate with a wireless node via a first wireless communication link;
encode a grant of resources with a shared radio network temporary identifier that is shared by both the wireless node and a user equipment (UE), wherein the grant of resources is associated with a second wireless communication link for communication between the wireless node and the UE;
transmit, to the wireless node via the first wireless communication link, the grant of resources.

30. The apparatus of claim 29, wherein the instructions to transmit the grant of resources are executable by the processor to cause the apparatus to:
transmit a downlink control information message that includes the grant of resources in a search space of a control resource set associated with the wireless node on the first wireless communication link, wherein the downlink control information message is encoded with the shared radio network temporary identifier which is an identifier of the wireless node.
